(19) United States
(12) Patent Application Publication
(10) Pub. No.: US 2024/0421288 A1
(43) Pub. Date: Dec. 19, 2024

(54) COMPOSITE MATERIALS PROVIDING IMPROVED BATTERY PERFORMANCE AND METHODS OF MANUFACTURE THEREOF

(71) Applicant: Aspen Aerogels, Inc., Northborough, MA (US)

(72) Inventors: Redouane BEGAG, Hudson, MA (US); Nicholas LEVENTIS, Worcester, MA (US); Nicholas A. ZAFIROPOULOS, Wayland, MA (US); Wendell RHINE, Belmont, MA (US); Ted Hosang LEE, Marlborough, MA (US)

(21) Appl. No.: 18/697,666

(22) PCT Filed: Dec. 9, 2022
(86) PCT No.: PCT/US2022/081240

§ 371 Date: Apr. 1, 2024

Related U.S. Application Data
(60) Provisional application No. 63/385,845, filed on Dec. 2, 2022.
(60) Provisional application No. 63/287,600, filed on Dec. 9, 2021.

(51) Int. Cl. H01M 4/36; C01B 32/05; H01M 4/587

(52) U.S. Cl. CPC H01M 4/366; C01B 32/05; H01M 4/587; C01P 2004/86; C01P 2006/11; C01P 2006/40

(57) ABSTRACT

Provided herein are composite materials for use in an electrical energy storage system (e.g., high-capacity batteries) and methods for preparing the same. The composite materials of the present disclosure comprise a carbon-based core having a porous exterior surface and a coating on at least a portion of the porous exterior surface of the core. Such coatings are made from a material that is (i) substantially permeable to at least one type of metal ions or metal atoms, and (ii) substantially impermeable to liquids

### CROSS-REFERENCE TO RELATED APPLICATIONS

This application claims priority to and benefit of U.S. provisional application No. 63/287,600 filed Dec. 9, 2021 and 63/385,845 filed Dec. 2, 2022, both entitled “COMPOSITE MATERIALS PROVIDING IMPROVED BATTERY PERFORMANCE AND METHODS OF MANUFACTURE THEREOF”. The contents of both applications are incorporated herein by reference in their entirety.

### FIELD OF THE TECHNOLOGY

The present disclosure relates generally to compositions and methods for improving performance of electrical energy storage systems. Specifically, this technology relates to composite materials suitable for use in high-capacity battery materials, for example as an electrode material within a lithium-ion battery. More specifically, this present disclosure relates to the composite materials comprising a carbon-based core and a coating made from a material that is (i) substantially permeable to at least one type of metal ions or metal atoms, and (ii) substantially impermeable to liquids.

### BACKGROUND

High-capacity battery materials e.g., Lithium-ion batteries have found wide application in power-driven and energy storage systems. Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries.

An electrochemical cell of a LIB is primarily comprised of positive electrode, negative electrode, electrolyte capable of conducting lithium-ions, separator electrically separating positive electrode and negative electrode, and current collectors. LiCoO₂(LCO), LiFePO₄ (LFP), LiMn₂O₄ (LMO), LiNi_{0.8} Co_{0.15}Al_{0.05}O₂ (NCA) and LiNiₓCo_{y}Mn_{z}O₂ (NMC) are five types of cathode material widely used in Li-ion batteries. These five kinds of batteries occupy a majority of market share in battery market today. The electrolyte is composed of a lithium salt dissolved in a specific solvent (mainly including ethylene carbonate (EC), diethyl carbonate (DEC), dimethyl carbonate (DMC), propylene carbonate (PC)). And the lithium salt is typically selected from LiClO₄, LiPF₆, LiBF₄, and LiBOB. Separator materials are generally polyolefin-based resin materials. Polypropylene (PP) and polyethylene (PE) micro-porous membranes are commonly used in commercial lithium-ion battery, as separators. Aluminum foil is usually used as current collector for positive electrode and copper foil for negative electrode. Carbon based materials, including hard carbon and graphite, are currently the primary choice for active materials in most negative electrodes of commercial lithium-ion batteries; other novel negative electrode materials, such as titanium-based oxides, alloy/de-alloy materials and conversion materials also have been investigated and showed good electrochemical performance.

Under normal operations, lithium ions move via diffusion and migration from one electrode to the other through the electrolyte and separator. Charging (de-lithiation) a LIB causes lithium ions in the electrolyte solution to migrate from the cathode through a separator and insert themselves in the anode. Charge balancing electrons also move to the anode but travel through an external circuit to power a device (such as computer, cell phone, electric vehicle). Upon discharge (lithiation), the reverse process occurs, and electrons flow through the device being powered.

During the lithiation and delithiation processes, the anode and cathode experience dimensional changes during charge and discharge that can lead to swelling of the cell. Thus, materials used in the cells (e.g., electrode materials) typically suffer from large volumetric changes during cycling that can subsequently impart large stresses on the cell. Silicon, for instance, has a typical volume change of up to 300% during lithiation while graphite has a volume expansion of approximately 10%. The resulting stresses can cause surface and intergranular cracking of electrode materials, leading to pulverization of electrode particles and creation of new surfaces for the formation and growth of the solid-electrolyte interphase (SEI) layer. Consequently, these stresses that destroy the integrity of electrodes result in capacity and power fade leading to poor cycle life and performance of the batteries.

These mechanical degradation mechanisms have been found to be strongly coupled with chemical degradation and have great influence on the cycle lifetime of lithium-ion batteries. The effect of swelling becomes increasingly important as higher capacity materials with higher volumetric expansions (e.g., silicon) are incorporated into battery electrodes.

### SUMMARY

Embodiments disclosed herein address one or more of the problems and deficiencies identified above by providing improved battery components, improved batteries made therefrom, and methods of making and using the same. However, it is contemplated that the present disclosure may prove useful in addressing other problems and deficiencies in a number of technical areas. Therefore, the claimed subject matter should not necessarily be construed as limited to addressing any of the particular problems or deficiencies discussed herein.

It is an object of the present disclosure to obviate or mitigate at least one disadvantage of previous methods and materials for improving performance (e.g., cycling stability, battery life-time of high-capacity batteries, such as, e.g., Lithium-ion batteries).

In one general aspect, the present disclosure provides composite materials for use in electrical energy storage systems e.g., Lithium-ion batteries. The composite materials of the present disclosure may advantageously inhibit or mitigate volume expansion (swelling) of electrode materials during charging and discharging, thereby improving performance of batteries (e.g., capacity, life-time, cycling stability, or combination thereof).

In one general aspect, the composite materials disclosed herein comprises a carbon-based core having a porous exterior surface; and a coating on at least a portion of the porous exterior surface of the carbon-based core. The coating of the present disclosure is made from materials that are (i) substantially permeable to at least one type of metal ions or metal atoms, and (ii) substantially impermeable to liquids. The coatings disclosed herein may act as a barrier to prevent electrolyte of a battery cell e.g., Li-ion battery cell to penetrate to the carbon-based core. The carbon-based core can be used as a component of an electrode. The coating, which is substantially impermeable to liquids, inhibits or mitigates swelling of the carbon-based core during charging and discharging processes. Without wishing to be bound by theory, inhibition or mitigation of swelling of the core improves battery performance.

In another aspect, the coating of the present disclosure mitigates continued formation of solid electrolyte interphase (SEI) on the porous exterior surface of carbon-based core.

The composite materials of the present technology can improve the performance of Lithium-ion batteries, relative to Lithium-ion batteries having electrodes which do not possess the composite material of the present disclosure.

Carbon-based aerogels can have properties (e.g., pore volume, pore size distribution, morphology, etc.) that can be tailored or modified, depending on the precursor materials and/or methodologies used. In one aspect, the present disclosure uses coated carbon-based aerogels as electrode materials with an increase in performance for applications in energy storage devices, such as lithium-metal anodes for high-energy batteries.

The use of composite materials of the present technology in high capacity batteries such as Li-ion batteries provides several advantages, including (i) providing volume for active material expansion without electrode swelling during charging and discharging processes; (ii) providing an electrical conduction medium that facilitates electron transport between electrode active particles; (iii) modifying electrode surface chemistry that changes electrochemical properties of the electrode surface to improve stability and performance; (iv) providing physical protection barrier that suppresses electrolyte reduction to form SEI on the core, thereby increasing a battery performance. Some composite materials disclosed herein may enhance all aspects of the performance. Others may only enhance one or several (but not all) aspects of performance.

In one aspect, provided herein is a composite material for use in an electrical energy storage system, the composite material including: a carbon-based core having a porous exterior surface; and a coating on at least a portion of the porous exterior surface of the carbon-based core, wherein the coating is (i) substantially permeable to at least one type of metal ions or metal atoms, and (ii) substantially impermeable to liquid molecules.

In some examples, the liquid molecules comprise an electrolyte solvent. In some examples, the electrolyte solvent is selected from ethylene carbonate (EC), diethyl carbonate (DEC), dimethyl carbonate (DMC), fluoroethylene carbonate (FEC), fluorinated ether (F-EPE), 1,3-dioxolane (DOL), dimethoxyethane (DME), ethyl methyl carbonate (EMC), propylene carbonate (PC), butylene carbonate (BC), ethylene sulfite (ES), propylene sulfite (PS), diethyl sulfite (DES), gamma-Butyrolactone (BL), dimethyl sulfoxide (DMSO), ethyl acetate (EP), methyl acetate (MA), or combination thereof.

In some examples, at least one type of metal ions are lithium ions. In some examples, at least one type of metal atoms are lithium atoms.

In some examples, the coating on at least a portion of the porous exterior surface of the carbon-based core has a thickness, and that thickness is less than or equal to about 2,500 nm. In some examples, the coating on at least a portion of the porous exterior surface of the carbon-based core has a thickness between about 100 nm and about 2,000 nm, or a thickness of about 200 nm to 500 nm. In some examples, the coating extends into porous exterior surface of the carbon-based core. In some examples, the coating extends into the porous exterior surface of the carbon-based core at a depth of less than or equal to about 2,500 nm, or between about 100 nm and about 2,000 nm, or about 200 nm to 500 nm. In some examples, the coating is uniform on at least a portion of the porous exterior surface of the core. In some examples, the coating is continuous on at least a portion of the porous exterior surface of the core. In some examples, wherein at least a portion of the porous exterior surface of the core is at least 70% of the exterior surface, at least 90% of the exterior surface, or at least 95% of the exterior surface. In some examples, the coating comprises an electrically conducting material. In some examples, the electrically conducting material is formed from a precursor of an electrically non-conducting material. In some examples, the electrically conducting material is carbon. In some examples, the electrically non-conducting material is a polymer. In some examples, the electrically conducting material is formed from a precursor of a first electrically conducting material. In some examples, the first electrically conducting material is selected from a metal or a transition metal. In some examples, the first electrically conducting material is selected from a carbon material. In some examples, the electrically conducting material is pitch-derived carbon, e.g., a soft carbon. In some examples, the precursor of the first electrically conducting material includes pitch.

In some examples, the coating comprises materials selected from an organic molecule, a polymer, a metal, a transition metal, a non-metal, a metal-organic framework (MOF), or combination thereof. In some examples, the polymer is selected from the group of polyacrylonitriles (PANs), polymethyl methacrylate (PMMA), polyimides, polyamides, or derivatives thereof. In a specific example, the coating comprises a polyacrylonitrile (PAN). In some examples, the organic molecule, the polymer, or the combination thereof are carbonized. In one example, the coating comprises carbonized polyacrylonitrile (PAN). In some examples, the coating is a carbon-based coating. In some examples, the carbon-based coating derives from pitch. That is, in some examples, the coating is a pitch-derived carbon coating. In one example, the pitch-derived carbon coating comprises soft carbon.

In some examples, the coating penetrates into the pores of the carbon-based core. In some examples, the carbon-based core has a low bulk density, wherein the low bulk density is in the range of about 0.25 g/cc to about 1.0 g/cc. In some examples, the carbon-based core has a pore volume of at least 0.3 cc/g. In some examples, the carbon-based core has a porosity between about 10% and about 90% of volume of the core.

In some examples, the carbon-based core comprises a skeletal framework. For example, the skeletal framework can comprise carbon nanofibers. In some examples, the skeletal framework comprises an array of interconnected pores.

In some examples, the carbon-based core is a monolith.

In some examples, the carbon-based core is in the form of particles. In some examples, the particles are substantially spherical, having a diameter from about 100 nm to about 4 mm, or from about 5 μm to about 4 mm.

In some examples, the carbon-based core comprises a carbon-based aerogel, a carbon based xerogel, a carbon-based ambigel, a carbon-based aerogel-xerogel hybrid material, a carbon-based aerogel-ambigel hybrid material, a carbon-based aerogel-ambigel-xerogel hybrid material, or combinations thereof. In some examples, the carbon-based core comprises an activated carbon, a carbon black, a carbon fiber, a carbon nanotube, a pyrolytic carbon, a graphite, a graphene, or combinations thereof.

In some examples, the carbon-based core comprises one or more additives, the additives being present at a level of at least about 0.1 to 80 percent by weight of the carbon-based core. In some examples, the additives comprise one or more electrochemically active dopants. The one or more electrochemically active dopants are selected from the group consisting of but not limited to lithium, sodium, potassium, calcium, magnesium, aluminum, iron, tin, lead, copper, mercury, manganese, vanadium, titanium, molybdenum, niobium, tungsten, zinc, silver, platinum, gold, carbon, boron, gallium, silicon, germanium, phosphorous, antimony. In one example, the electrochemically active dopants are selected from the group consisting of but not limited to silicon, germanium, tin, antimony, gold, silver, zinc, magnesium, platinum, and aluminum.

In some examples, the coating comprises a conductive additive. The conductive additive comprises a carbon, a carbon nanotube, a graphene, a graphite, a metal, a metal oxide, a silicon carbide, or combination thereof.

In some examples, the carbon-based core has a capacity of between about 200 mAh/g and about 3000 mAh/g. In some examples, the carbon-based core has an electrical conductivity of at least about 1 S/cm. In some examples, the coating has an electrical conductivity of at least about 1 S/cm.

In some examples, the energy storage system in which the composite material of the present technology is incorporated is a battery. In some examples, the battery is a rechargeable battery. In some examples, the rechargeable battery is Li-ion battery.

In one aspect, provided herein is a rechargeable battery comprising the composite material of the present technology disclosed herein.

In another aspect, provided herein is a method of improving the performance of a rechargeable battery comprising incorporating the composite material disclosed herein into the rechargeable battery.

In another aspect provided herein is a method of preparing the composite material of the present disclosure. This method comprises: providing a carbon-based core having an porous exterior surface; and coating at least a portion of the porous exterior surface of the core, thereby obtaining the composite material.

In some examples, the method of preparing the composite material of the present disclosure further comprises a step of subcritical or supercritical drying prior to the step of coating at least a portion of the porous exterior surface of the core. In some examples, the method further comprises a carbonization step between the step of coating at least a portion of the porous exterior surface of the core and the step of subcritical or supercritical drying. In one example, the method further comprises second carbonization step after the step of coating at least a portion of the porous exterior surface of the core.

In some examples, the method of preparing the composite material of the present disclosure further comprises a step of subcritical or supercritical drying after the step of coating at least a portion of the porous exterior surface of the core. In some examples, further comprises a carbonization step after the step of subcritical or supercritical drying of the composite material.

In some examples the step of coating at least a portion of the porous exterior surface of the core comprises coagulation process. In another example, the step of coating at least a portion of the porous exterior surface of the core comprises spray coating process. In some examples, the spray coating process comprises a fast spray drying method using an atomized feed. In some examples, the step of coating at least a portion of the porous exterior surface of the core comprises dip coating process.

In some examples the step of coating at least a portion of the porous exterior surface of the core comprises

### BRIEF DESCRIPTION OF THE DRAWINGS

The technology will be more fully understood from the following detailed description taken in conjunction with the accompanying drawings, in which:

FIG. 1 shows exemplary bead coating processes that is suitable for applying to the carbon-based core of the present disclosure.

FIG. 2 shows the preparation scheme for coating of C/Si beads with PAN using coagulation process

FIG. 3 shows two different routes of applying PAN coating on the surface of C/Si beads.

FIG. 4A and FIG. 4B display scanning electron microscope (SEM) pictures of sample A showing carbon coating layer (from PAN coagulation process 1, route 1) on the bead. FIG. 4A shows a portion of the coated bead and FIG. 4B shows a higher magnification view of a portion of the coating on the surface of the bead shown in FIG. 4A.

FIG. 5A, FIG. 5B, and FIG. 5C show SEM images of sample B (a PAN-coated aerogel bead using process 1, route 2). FIG. 5A is an image of one of the coated beads (sample B). FIG. 5B is a higher magnification of a portion of the bead of FIG. 5A and FIG. 5C is an even higher magnification of the portion of the bead.

FIG. 6 shows an SEM image of sample C (fully PAN-coated carbon aerogel beads, coating created using process 2, route 1).

FIG. 7A and FIG. 7B show higher magnification images of sample C. FIG. 7A shows two beads connected together by the coating and FIG. 7B is a higher magnification of the coating at the neck/intersection of the beads.

FIG. 8 shows an SEM image of sample D (fully PAN-coated carbon aerogel beads, coating created using process 2, route 2).

FIG. 9A and FIG. 9B show higher magnification images of sample D. FIG. 9A shows two beads connected together by the coating and FIG. 9B is a higher magnification of the coating at the neck/intersection of the beads.

FIG. 10A and FIG. 10B shows SEM images of sample D at high magnification showing PAN coating layer on fibrillous carbon aerogel structure. FIG. 10A shows a portion of the coated surface. FIG. 10 B is a higher magnification view of the coating.

### DETAILED DESCRIPTION

As discussed above, for certain active materials of interest (e.g., silicon), the storing and releasing of these ions (e.g., Li ions in a Li-ion battery) causes a substantial change in volume of the active material, which, in conventional designs, may lead to irreversible mechanical damage, and ultimately a loss of contact between individual electrode particles or between the electrode and underlying current collector. Moreover, it may lead to continuous growth of the solid-electrolyte interphase (SEI) around such volume-changing particles.

A composite material comprising: a carbon-based core having an exterior surface; and a coating which is (i) substantially permeable to at least one type of metal ions or metal atoms, and (ii) substantially impermeable to liquids is provided to address these issues described above. Without wishing to be bound by theory, the carbon-based core structurally supports the active material, electrically interconnects the active material, and accommodates the changes in volume of the active material discussed above. In general, the composite particles may be able to accommodate changes in volume of the active material during battery operation

Such advantages are provided for a wide range of high-capacity anode and cathode materials. In addition, advantages are particularly provided for high-capacity anode and cathode materials (e.g., greater than about 250 mAh/g for Li-ion battery cathodes and greater than about 400 mAh/g for Li-ion battery anodes) that exhibit significant volume changes (e.g., greater than about 10%) upon insertion and extraction of ions (e.g., metal ions). For anodes the composite materials of this disclosure can be used in metal-ion (e.g. Li-ion) batteries, examples include but are not limited to: heavily doped, doped and undoped Si, In, Sn, Sb, Ge, Mg, Pb, their alloys with other metals and semimetals, their mixtures with other metals, metal oxides, metal fluorides, metal oxy-fluorides, metal nitrides, metal phosphides, metal sulfides and semiconductor oxides, and their mixtures with hard carbon, graphite, graphene, and/or other carbon based materials. For cathodes the composite materials of this disclosure can be used in metal-ion (e.g., Li-ion) batteries, examples include but are not limited to: LCO, LFP, LMO, NCA, NMC, metal sulfides, metal fluorides, metal oxy-fluorides, and their mixtures. In the description below, several examples are provided in the context of aqueous Li-ion batteries because of the current prevalence and popularity of Li-ion technology. However, it will be appreciated that such examples are provided merely to aid in the understanding and illustration of the underlying techniques, and that these techniques may be similarly applied to various other metal-ion batteries, such as Li⁺, Na⁺, Mg²⁺, Ca²⁺, and Al³⁺, and other aqueous metal-ion batteries. The composite material of the present disclosure can be used in other battery chemistries where active particles undergo significant volume changes during their operation (e.g., reversible reduction-oxidation reactions), including, for example, aqueous electrolyte-containing batteries.

### Definitions

As used herein, the term “about” means that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments.

As used herein, the term “optional” or “optionally” refers to a described event or circumstance may or may not occur, and that the description includes instances where the event or circumstance occurs and instances where the event or circumstance does not occur.

As used herein, the term “uniform” refers to a variation in the thickness of a material e.g., the coating of the present disclosure of less than about 10%, less than about 5%, or less than about 1%.

As used herein, the term “continuous” refers to a layer free of gaps, holes, or any discontinuities. For example, a continuous layer that does not include two (or more) component materials physically separated (or spaced apart) within this layer.

As used herein, in the context of a particle size, the term “D50” means that half of the population of particles has a particle size above this point, and half below. D90 particle size distribution indicates that 90% of the particles (by number) have a Feret diameter below a certain size as measured by Scanning Electron Microscopy (SEM) or Transmission Electron Microscopy (TEM). D10 particle size distribution indicates that 10% of the particles (by number) have a Feret diameter below a certain size as measured by Scanning Electron Microscopy (SEM) or Transmission Electron Microscopy (TEM).

As used herein, the term “pitch” refers to a viscoelastic polymer which can be natural or manufactured, derived from petroleum, coal tar, or plants. Pitch is generally obtained as a result of heat treatment and subsequent distillation of coal tar or petroleum fractions. It is composed essentially by a mixture of aromatic hydrocarbons. Exemplary pitch includes petroleum pitch, coat tar pitch, and chemically processed pitches. Preferred compounds include those with high carbon content after thermal decomposition, for example, the carbon content being in the range of about 1% to about 20%.

As used herein, the term “xerogel” refers to a gel dried under subcritical conditions, i.e., the majority solvent is not in the supercritical fluid state under these conditions.

As used herein, the term “ambigel” refers to a gel dried at atmospheric pressure.

### Carbon-Based Core

In some examples, the carbon-based core includes a carbon-based aerogel, a carbon based xerogel, a carbon-based ambigel, a carbon-based aerogel-xerogel hybrid material, a carbon-based aerogel-ambigel hybrid material, a carbon-based aerogel-ambigel-xerogel hybrid material, or combinations thereof.

The aerogels used in the present disclosure may be carbonized to obtain carbon-based aerogel of this present technology. Carbonization may be carried out by pyrolysis at elevated temperatures in an inert atmosphere. The carbonized forms of the aerogels used in the present disclosure may have the nitrogen content between 0 and 20%. Typical pyrolysis temperatures range between 500° C. and 2000° C. Temperature may be increased to reduce the nitrogen content of the resulting carbon aerogel. Pyrolysis is typically carried out in an inert atmosphere (i.e. nitrogen, helium, neon, argon or some combination).

The aerogels used in the present disclosure may also comprise silica components.

In some examples, the present disclosure involves the formation and use of carbon-based core, such as carbon aerogels, as electrode materials within an energy storage device, for example as the primary anodic material in a LIB. The pores of the porous core are designed, organized, and structured to accommodate particles of silicon or other metalloid or metal, and expansion of such particles upon lithiation in LIB, for example. Alternatively, the pores of the porous core may be filled with sulfide, hydride, any suitable polymer, or other additive where there is benefit to contacting the additive with an electrically conductive material to provide for a more effective electrode.

Aerogels are solid materials that include a highly porous network of micro-sized and meso-sized pores. Depending on precursor materials used and processing undertaken, the pores of an aerogel can account for over 90% of the volume when the density of the aerogel is about 0.05 g/cc. Aerogels can be prepared by removing the solvent from a gel (a solid network that contains its solvent) in a manner that minimal or no contraction of the gel can be brought by capillary forces at its surface. Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that subsequently transformed to supercritical state, sub- or near-critical drying, and sublimating a frozen solvent in a freeze-drying process.

When drying in ambient conditions, gel contraction may take place with solvent evaporation, and an ambigel can form. Therefore, aerogel preparation through a sol-gel process or other polymerization processes can proceed in the following series of steps: dissolution of the solute in a solvent, formation of the sol/solution/mixture, formation of the gel (may involve additional cross-linking), and solvent removal by either supercritical drying technique or any other method that removes solvent from the gel with controlled pore collapse.

Aerogels can be formed of inorganic materials and/or organic materials. When formed of organic materials-such as phenols, resorcinol-formaldehyde (RF), phloroglucinol furfuraldehyde (PF), polyacrylonitrile (PAN), polyimide (PI), polyurethane (PU), polybutadiene, polydicyclopentadiene, and precursors or polymeric derivatives thereof, for example—the aerogel may be carbonized (e.g., by pyrolysis) to form a carbon aerogel.

Within the context of the present disclosure, the term “aerogel”, “aerogel material” or “aerogel matrix” refers to a gel comprising a framework of interconnected structures, with a corresponding network of interconnected pores integrated within the framework, and containing gases such as air as a dispersed interstitial medium; and which is characterized by the following physical and structural properties (according to Nitrogen Porosimetry Testing) attributable to aerogels: (a) an average pore diameter ranging from about 2 nm to about 100 nm, (b) a porosity of at least 80% or more, and (c) a surface area of about 100 m²/g or more.

Aerogel materials of the present disclosure that is used as a carbon-based core thus include any aerogels or other open-celled materials which satisfy the defining elements set forth in previous paragraphs; including materials which can be otherwise categorized as xerogels, cryogels, ambigels, microporous materials, and the like.

Aerogel materials may also be further characterized by additional physical properties, including: (d) a pore volume of about 2.0 mL/g or more, particularly about 3.0 mL/g or more; (e) a density of about 0.50 g/cc or less, particularly about 0.3 g/cc or less, more particularly about 0.25 g/cc or less; and (f) at least 50% of the total pore volume comprising pores having a pore diameter of between 2 and 50 nm (although embodiments disclosed herein include aerogel frameworks and compositions that include pores having a pore diameter greater than 50 nm, as discussed in more detail below). However, satisfaction of these additional properties is not required for the characterization of a compound as an aerogel material.

To further expand on the exemplary application within LIBs, when carbon aerogel material is used as the primary electrode material e.g., anodic material as in examples of this present disclosure, the aerogel porous core has a narrow pore size distribution, and provides for high electrical conductivity, high mechanical strength, and a morphology and sufficient pore volume (at a final density) to accommodate a high percentage by weight of silicon particles and expansion thereof.

In some examples, the surface of the carbon aerogel may be modified via chemical, physical, or mechanical methods in order to enhance performance with electrochemically active species contained within the pores of the carbon aerogel.

It should be appreciated that while the present disclosure describes multiple embodiments utilizing a carbon aerogel-based core, other carbon based materials can be used in its place. For example, other open-celled materials, such as, xerogels, cryogels, ambigels, and microporous materials can be used in place of, or together with, aerogels.

Carbon aerogel itself can function as a current collector due to its electrical conductivity and mechanical strength, thus, eliminating the need for a distinct current collector on the cathode side or anode side (when the cathode or anode, respectively, is formed of the carbon aerogel). In the majority of LIBs, aluminum foil or copper foil is required to be coupled to the cathode or anode, respectively, as its current collector. However, removal of one or both of these components, depending on the application of the carbon aerogel, derives additional space for more electrode material, resulting in even greater capacity of the cell/individual electrode and overall greater energy density of the packaged battery system. However, in some examples, existing current collectors may be integrated with the cathode and anode materials of various other examples to augment the aluminum foil's and copper foil's current collection capabilities or capacities.

In some examples, carbon-based cores, and specifically the carbon aerogel can be used as the conductive network or current collector on the anode side of an energy storage device. The fully interconnected carbon aerogel network is filled with electrochemically active species, where the electrochemically active species are in direct contact or physically connected to the carbon network. Loading of electrochemically active species is tuned with respect to pore volume and porosity for high and stable capacity and improved energy storage device safety. When utilized on the anode side, the electrochemically active species may include, for example, silicon, graphite, lithium or other metalloids or metals. The anode can comprise carbon-based cores, and specifically carbon aerogels.

Within the context of the present disclosure, the term “collector-less” refers to the absence of a distinct current collector that is directly connected to an electrode. As noted, in conventional LIBs, a copper foil is coupled to the anode as its current collector. Electrodes formed from carbon-based cores (e.g., carbon aerogels), according to examples of the present disclosure, can be a freestanding structure or otherwise have the capability of being collector-less since the scaffold or structure itself functions as the current collector, due to its high electrical conductivity. Within the electrochemical cell, a collector-less electrode can be connected to form a circuit by embedding solid, mesh, woven tabs during the solution step of making the continuous porous carbon; or by soldering, welding, or metal depositing leads onto a portion of the porous carbon surface. Other mechanisms of contacting the carbon to the remainder of the system are contemplated herein as well. In some examples, the carbon-based scaffolds or structures, and specifically a carbon aerogel may be disposed on or otherwise in communication with a dedicated current-collecting substrate (e.g., copper foil, aluminum foil, etc.). In this scenario, the carbon aerogel can be attached to a solid current collector using a conductive adhesive and applied with varying amounts of pressure.

Furthermore, it is contemplated herein that the carbon-based core, and specifically carbon aerogels, can take the form of monolithic structures. When monolithic in nature, the carbon aerogel eliminates the need for any binders; in other words, the anode can be binder-less. As used herein, the term “monolithic” refers to aerogel materials in which a majority (by weight) of the aerogel included in the aerogel material or composition is in the form of a unitary, continuous, interconnected aerogel nanostructure. Monolithic aerogel materials include aerogel materials which are initially formed to have a unitary interconnected gel or aerogel nanostructure, but which can be subsequently cracked, fractured or segmented into non-unitary aerogel nanostructures. Monolithic aerogels may take the form of a freestanding structure or a reinforced (fiber or foam) material. In comparison, using silicon lithiation as an example, silicon incorporated into a monolithic aerogel can be utilized more effectively relative to theoretical capacity, as compared to the same amount of silicon incorporated into a slurry using conventional processes.

Monolithic aerogel materials are differentiated from particulate aerogel materials. The term “particulate aerogel material” refers to aerogel materials in which a majority (by weight) of the aerogel included in the aerogel material is in the form of particulates, particles, granules, beads, or powders, which can be combined together (i.e., via a binder, such as a polymer binder) or compressed together but which lack an interconnected aerogel nanostructure between individual particles. Collectively, aerogel materials of this form will be referred to as having a powder or particulate form (as opposed to a monolithic form). It should be noted that despite an individual particle of a powder having a unitary structure, the individual particle is not considered herein as a monolith. Integration of aerogel powder into an electrochemical cell typically preparation of a paste or slurry from the powder, casting and drying onto a substrate, and may optionally include calendaring.

Particulate aerogel materials, e.g., aerogel beads, provide certain advantages. For example, particulate materials can be used as a direct replacement for other materials such as graphite in LIB anodes and anode manufacturing processes. Particulate materials can also provide improved lithium ion diffusion rates due to shorter diffusion paths within the particulate material. Particulate materials can also allow for electrodes with enhanced packing densities, e.g., by tuning the particle size and packing arrangement. Particulate materials can also provide improved access to silicon due to inter-particle and intra-particle porosity.

Carbon-based cores, such as carbon aerogels, according to the present disclosure, can be formed from any suitable organic precursor materials. Examples of such materials include, but are not limited to, RF, PF, PI, polyamides, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations and derivatives thereof. Any precursors of these materials may be used to create and use the resulting materials. In some examples, the carbon aerogel is formed from a pyrolyzed/carbonized polyimide-based aerogel, i.e., the polymerization of polyimide. Even more specifically, the polyimide-based aerogel can be produced using one or more methodologies described in U.S. Pat. Nos. 7,071,287 and 7,074,880 to Rhine et al., e.g., by imidization of poly(amic) acid and drying the resulting gel using a supercritical fluid. Other adequate methods of producing polyimide aerogels (and carbon aerogels derived therefrom) are contemplated herein as well, for example as described in U.S. Pat. No. 6,399,669 to Suzuki et al.; U.S. Pat. No. 9,745,198 to Leventis et al.; Leventis et al., Polyimide Aerogels by Ring-Opening Metathesis Polymerization (ROMP), Chem. Mater. 2011, 23, 8, 2250-2261; Leventis et al., Isocyanate-Derived Organic Aerogels: Polyureas, Polyimides, Polyamides, MRS Proceedings, 1306 (2011), Mrsf10-1306-bb03-01. doi:10.1557/opl.2011.90; Chidambareswarapattar et al., One-step room-temperature synthesis of fibrous polyimide aerogels from anhydrides and isocyanates and conversion to isomorphic carbons, J. Mater. Chem., 2010, 20, 9666-9678; Guo et al., Polyimide Aerogels Cross-Linked through Amine Functionalized Polyoligomeric Silsesquioxane, ACS Appl. Mater. Interfaces 2011, 3, 546-552; Nguyen et al., Development of High Temperature, Flexible Polyimide Aerogels, American Chemical Society, proceedings published 2011; Meador et al., Mechanically Strong, Flexible Polyimide Aerogels Cross-Linked with Aromatic Triamine, ACS Appl. Mater. Interfaces, 2012, 4 (2), pp 536-544; Meador et al., Polyimide Aerogels with Amide Cross-Links: A Low Cost Alternative for Mechanically Strong Polymer Aerogels, ACS Appl. Mater. Interfaces 2015, 7, 1240-1249; Pei et al., Preparation and Characterization of Highly Cross-Linked Polyimide Aerogels Based on Polyimide Containing Trimethoxysilane Side Groups, Langmuir 2014, 30, 13375-13383. The resulting polyimide aerogel would then be pyrolyzed to form a polyimide-derived carbon aerogel.

Carbon aerogels of the present disclosure, e.g., polyimide-derived carbon aerogels, can have a residual nitrogen content of at least about 4 wt %. For example, carbon aerogels can have a residual nitrogen content of at least about 0.1 wt %, at least about 0.5 wt %, at least about 1 wt % at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or in a range between any two of these values.

In examples of the present disclosure, a dried polymeric aerogel composition can be subjected to a treatment temperature of 200° C. or above, 400° C. or above, 600° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the organic (e.g., polyimide) aerogel. In exemplary embodiments, a dried polymeric aerogel composition can be subjected to a treatment temperature in the range of about 1000° C. to about 1100° C., e.g., at about 1050° C. Without being bound by theory, it is contemplated herein that the electrical conductivity of the aerogel composition increases with carbonization temperature.

Within the context of the present disclosure, the term “electrical conductivity” refers to a measurement of the ability of a material to conduct an electric current or other allow the flow of electrons therethrough or therein. Electrical conductivity is specifically measured as the electric conductance/susceptance/admittance of a material per unit size of the material. It is typically recorded as S/m (Siemens/meter) or S/cm (Siemens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84—resistivity (R) measurements obtained by measuring voltage (V) divided by current (I), unless otherwise stated. Aerogel materials e.g. carbon-aerogels or compositions of the present disclosure can have an electrical conductivity of about 1 S/cm or more, about 5 S/cm or more, about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

Within the context of the present disclosure, the term “electrochemically active species” refers to an additive that can be used, e.g., in small quantities as a dopant, and is capable of accepting and releasing ions within an energy storage device. Using LIBs as an example, an electrochemically active species within the anode accepts lithium ions during charge and releases lithium ions during discharge. The electrochemically active species can be stabilized within the anode by having a direct/physical connection with the porous carbon core. The porous carbon network can form interconnected structures around the electrochemically active species. The electrochemically active species is connected to the porous carbon at a plurality of points. An example of an electrochemically active species is silicon, which expands upon lithiation and can crack or break. However, because silicon has multiple connection points with the porous carbon (aerogel), silicon can be retained and remain active within the porous structure, e.g., within the pores or otherwise encased by the structure, even upon breaking or cracking.

The electrochemically active species can be referred to as electrically active additives and can be used to promote infiltration and plating. For example, as a material for Li-metal anodes, silicon doping can be used to promote Li infiltration and initiate lithium plating. Besides silicon, other electrically active additives include gold, silver, zinc, magnesium, platinum, aluminum, tin, copper, nickel, and other dopants described herein. In some examples, an electrochemically active material can be used in small quantities as a dopant to seed lithium plating within the porosity of the carbon nanostructure.

Within the context of the present disclosure, the terms “compressive strength”, “flexural strength”, and “tensile strength” refer to the resistance of a material to breaking or fracture under compression forces, flexure or bending forces, and tension or pulling forces, respectively. These strengths are specifically measured as the amount of load/force per unit area resisting the load/force. It can be recorded as pounds per square inch (psi), megapascals (MPa), or gigapascals (GPa). Among other factors, the compressive strength, flexural strength, and tensile strength of a material collectively contribute to the material's structural integrity, which is beneficial, for example, to withstand volumetric expansion of silicon particles during lithiation in a LIB. Referring specifically to Young's modulus, which is an indication of mechanical strength, the modulus may be determined by methods known in the art, for example including, but not limited to: Standard Test Practice for Instrumented Indentation Testing (ASTM E2546, ASTM International, West Conshocken, PA); or Standardized Nanoindentation (ISO 14577, International Organization for Standardization, Switzerland). Within the context of the present disclosure, measurements of Young's modulus are acquired according to ASTM E2546 and ISO 14577, unless otherwise stated. In certain examples, aerogel materials e.g. carbon-aerogels or compositions of the present disclosure have a Young's modulus of about 0.2 GPa or more, 0.4 GPa or more, 0.6 GPa or more, 1 GPa or more, 2 GPa or more, 4 GPa or more, 6 GPa or more, 8 GPa or more, or in a range between any two of these values.

Within the context of the present disclosure, the term “pore size distribution” refers to the statistical distribution or relative amount of each pore size within a sample volume of a porous material. A narrower pore size distribution refers to a relatively large proportion of pores at a narrow range of pore sizes, thus enhancing the amount of pores that can surround the electrochemically active species and maximizing use of the pore volume. Conversely, a broader pore size distribution refers to relatively small proportion of pores at a narrow range of pore sizes. As such, pore size distribution can be measured as a function of pore volume and recorded as a unit size of a full width at half max of a predominant peak in a pore size distribution chart. The pore size distribution of a porous material may be determined by methods known in the art, for example including, but not limited to, surface area and porosity analyzer by nitrogen adsorption and desorption from which pore size distribution can be calculated. Within the context of the present disclosure, measurements of pore size distribution are acquired according to this method, unless otherwise stated. In some examples, aerogel materials e.g., carbon aerogels or compositions of the present disclosure have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

Within the context of the present disclosure, the term “pore volume” refers to the total volume of pores within a sample of porous material. Pore volume is specifically measured as the volume of void space within the porous material, where that void space may be measurable and/or may be accessible by another material, for example an electrochemically active species such as silicon particles. It can be recorded as cubic centimeters per gram (cm³/g or cc/g). The pore volume of a porous material may be determined by methods known in the art, for example including, but not limited to, surface area and porosity analyzer by nitrogen adsorption and desorption from which pore volume can be calculated. Within the context of the present disclosure, measurements of pore volume are acquired according to this method, unless otherwise stated. In certain examples, aerogel materials or compositions of the present disclosure (without incorporation of electrochemically active species, e.g., silicon particles) have a relatively large pore volume of about 0.5 cc/g or more, 1 cc/g or more, 1.5 cc/g or more, 2 cc/g or more, 2.5 cc/g or more, 3 cc/g or more, 3.5 cc/g or more, 4 cc/g or more, or in a range between any two of these values. In other examples, aerogel materials e.g. carbon-aerogels or compositions of the present disclosure (with incorporation of electrochemically active species, e.g., silicon particles) have a pore volume of about 0.10 cc/g or more, 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values.

Within the context of the present disclosure, the term “porosity” refers to a volumetric ratio of pores that does not contain another material (e.g., an electrochemically active species such as silicon particles) bonded to the walls of the pores. For clarification and illustration purposes, it should be noted that within the specific implementation of silicon-doped carbon aerogel as the primary anodic material in a LIB, porosity refers to the void space after inclusion of silicon particles. Porosity may be determined by methods known in the art, for example including, but not limited to, the ratio of the pore volume of the aerogel material to its bulk density. Within the context of the present disclosure, measurements of porosity are acquired according to this method, unless otherwise stated. In certain examples, aerogel materials e.g. carbon aerogels or compositions of the present disclosure have a porosity of about 90% or less, 80% or less, 70% or less, 60% or less, 50% or less, 40% or less, 30% or less, 20% or less, 10% or less, or in a range between any two of these values.

It should be noted that pore volume and porosity are different measures for the same property of the pore structure, namely the “empty space” within the pore structure. For example, when silicon is used as the electrochemically active species surrounded within the pores of the nanoporous carbon material, pore volume and porosity refer to the space that is “empty”, namely the space not utilized by the carbon or the electrochemically active species. As will be seen, densification, e.g., by compression, of the pre-carbonized porous material can also have an effect on pore volume and porosity, among other properties.

Within the context of the present disclosure, the term “pore size at max peak from distribution” refers to the value at the discernible peak on a graph illustrating pore size distribution. Pore size at max peak from distribution is specifically measured as the pore size at which the greatest percentage of pores is formed. It can be recorded as any unit length of pore size, for example m or nm. The pore size at max peak from distribution may be determined by methods known in the art, for example including, but not limited to, surface area and porosity analyzer by nitrogen adsorption and desorption from which pore size distribution can be calculated and pore size at max peak can be determined. Within the context of the present disclosure, measurements of pore size at max peak from distribution are acquired according to this method, unless otherwise stated. Aerogel materials e.g. carbon-aerogels or compositions of the present disclosure can have a pore size at max peak from distribution of about 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values.

Within the context of the present disclosure, the term “capacity” refers to the amount of specific energy or charge that a battery is able to store. In some examples, capacity refers to reversible capacity. Capacity is specifically measured as the discharge current that the battery can deliver over time, per unit mass. It can be recorded as ampere-hours or milliampere-hours per gram of total electrode mass, Ah/g or mAh/g. The capacity of a battery (and a anode in particular) may be determined by methods known in the art, for example including, but not limited to: applying a fixed constant current load to a fully charged cell until the cell's voltage reaches the end of discharge voltage value; the time to reach end of discharge voltage multiplied by the constant current is the discharge capacity; by dividing the discharge capacity by the weight of electrode material or volume, specific and volumetric capacities can be determined. Within the context of the present disclosure, measurements of capacity are acquired according to this method, unless otherwise stated. Aerogel materials e.g. carbon-aerogels or compositions of the present disclosure can have an anode capacity of about 100 mAh/g or more, 150 mAh/g or more, 200 mAh/g or more, 300 mAh/g or more, 400 mAh/g or more, 500 mAh/g or more, 600 mAh/g or more, 700 mAh/g or more, 800 mAh/g or more, 900 mAh/g or more, 1000 mAh/g or more, 1100 mAh/g or more, 1200 mAh/g or more, 1300 mAh/g or more, 1400 mAh/g or more, 1500 mAh/g or more, 1600 mAh/g or more, 1700 mAh/g or more, 1800 mAh/g or more, 1900 mAh/g or more, 2000 mAh/g or more, 2500 mAh/g or more, 3000 mAh/g or more, or in a range between any two of these values or any intervening value (e.g. 520 mAh/g).

It is contemplated herein that the pore size is tunable as needed. There are five primary methods of adjusting pore size taught herein. First, the amount of solids content, specifically the amount of polyimide precursor monomers (e.g., aromatic or aliphatic diamine and aromatic or aliphatic dianhydride), can adjust pore size. Smaller pore sizes result from a greater amount of solids per unit volume of fluid, due to less room being available such that inter-connection takes place more closely. It should be noted that strut width does not change measurably, regardless of the amount of solids used. The amount of solids relates more so to how dense the network will be.

Adjusting pore size can be accomplished with the use of radiation (e.g., radio wave, microwave, infrared, visible light, ultraviolet, X-ray, gamma ray) on the composite in either polyimide state or in carbon state. Radiation has an oxidizing effect, resulting in an increase in surface area, increase in pore size, and broadening of pore size distribution. Thirdly, pore size is affected by a macroscopic compression of the polyimide composite. In some examples, pore size reduces with compression.

Adjusting pore size can be accomplished with ion bombardment of the composite in either polyimide state or carbon state. The effect of ion bombardment depends on the method designated. For example, there is additive ion bombardment (e.g., CVD), where something is added, resulting in a reduction of pore size. There is also destructive ion bombardment, where pore size would increase. Finally, pore size can be adjusted (increase or decrease) with heat treatment under different gas environments, for example presence of carbon dioxide or carbon monoxide, chemically active environments, hydrogen reducing environments, etc. A carbon dioxide environment, for example, is known to make activated carbon, where in instances of activation, mass is removed, pore size increases, and surface area increases.

Lithium can be used with carbon aerogels in a variety of manners including being pre-deposited by ex situ lithium plating or melt infusion prior to cell assembly. For pre-deposited lithium in carbon aerogel, examples include carbon aerogel pre-treated to promote Li infiltration and carbon aerogel pre-doped with Si (a known additive to promote Li infiltration). For carbon aerogel lithiated (or plated) in situ during formation, examples include providing enough Li to be available in the electrolyte and cathode that upon initial charging, the carbon aerogel becomes plated such that no more than 50% of Li is lost to SEI formation.

Lithium in carbon aerogel can have several forms including free-standing carbon aerogel monolith, carbon aerogel on copper current collector, carbon aerogel on lithium metal, and carbon aerogel beads. Carbon aerogel has high electrical conductivity and can serve as a current collector. Beads can be used in standard battery manufacturing slurry/casting methods. Beads of certain dimension and particle size distribution can be manufactured and then infiltrated with Li metal in bulk on individual beads and post casted beads as electrodes.

For carbon aerogels, infiltration of lithium can be accomplished via melt infusion and electrodeposition. The narrow and controllable particle size distribution helps provide uniform lithium deposition during charging, which can help reduce or prevent dendrite formation. In one embodiment where the carbon aerogel resides between the lithium metal and separator, during operation of the battery, the carbon aerogel is reduced upon charging and Li ions—from the Li metal underlayer and electrolyte—deposit on the surface of the carbon aerogel. Subsequently, upon discharge, the stored Li ions in the carbon aerogel are released and the Li metal underlayer can continue to resupply Li ions as needed while not allowing dendrites to propagate. The carbon aerogel moderator/barrier layer is prepared with a desired surface area, pore size, and pore size distribution to achieve high capacity, long cycle life, good rate capability and improved safety.

Within the context of the present disclosure, the terms “char content” and “char yield” refer to the amount of carbonized organic material present in an organic aerogel after exposing the aerogel to high-temperature pyrolysis. The char content of an aerogel can be expressed as a percentage of the amount of organic material present in the aerogel framework after high-temperature pyrolytic treatment, relative to the total amount of material in the original aerogel framework prior to high-temperature pyrolytic treatment. This percentage can be measured using thermo-gravimetric analysis, such as TG-DSC analysis. Specifically, the char yield in an organic aerogel can be correlated with the percentage of weight retained by an organic aerogel material when subjected to high carbonization temperatures during a TG-DSC analysis (with weight loss resulting from moisture evaporation, organic off-gassing, and other materials lost from the aerogel framework during high-temperature pyrolytic treatment). For the purposes of the present disclosure, char yield is correlated with a carbonization exposure temperature up to 1000° C. Preferably, aerogel materials of the present disclosure that can serve as a precursor of the carbon-based aerogels can have a char yield of about 50% or more, about 55% or more, about 60% or more, about 65% or more, or about 70% or more.

### Coating Material

The coating materials of the present disclosure are used to coat the porous exterior surface of the carbon-based cores disclosed herein.

Without wishing to be bound by theory, the coatings disclosed herein may act as a barrier to prevent electrolyte of a battery cell (e.g., Li-ion battery cell) to penetrate to the carbon-based core which can be used as a component of an electrode, thereby inhibiting or mitigating swelling of the carbon-based core during charging and discharging processes. Such coatings may also assist in improving abrasion resistance, chemical resistance and shape forming for carbon-based core (e.g., a porous carbon-based material, such as, an aerogel, ambigel, xerogel, cryogel, etc.).

The coating may be electrically conductive or non-conductive.

In some examples, the coating may filter passage of other atoms and/or molecules on the basis of their sizes. In some examples, the coating is tailored to support size selectivity in ionic and molecular diffusion. For example, coating may allow lithium ions to diffuse freely but larger cations, such as cathode metals and molecules such as electrolyte species, are blocked. In some examples, the coatings disclosed herein can serve as a metal ion e.g., Li-ion diffusion barrier, wherein lithium ions have a migration barrier through the coating of about 0.7 eV or smaller. The term “diffusion barrier” used herein refers to a potential which needs to be overcome when Li-ions move under the action of concentration gradient.

The coating may include materials selected from an organic molecule, a polymer, a metal, a transition metal, a non-metal, a metal-organic framework (MOF), or combination thereof. Or, the coating may be formed from precursor(s) of an organic molecule, a polymer, a metal, a transition metal, a non-metal, a metal-organic framework (MOF), or combination thereof. In some examples, the polymer is selected from the group of polyacrylonitriles (PANs), polymethyl methacrylate (PMMA), polyimides, polyamides, or derivatives thereof. In some examples, the organic molecule, the polymer, or the combination thereof are carbonized at temperature>1000° C., 800° C., 700° C. or 650° C. In some examples, the organic molecule, the polymer, or the combination thereof are cyclized at temperature>400° C., 300° C. or 250° C.

In general, suitable polymers for coating the exterior surface of a carbon-based core includes most any hydrocarbon based organic polymers including thermoplastics and thermosets. Such polymers may be selected from but not limited to: polyimides, polyamides, polyarylamides, polybenzimidazoles, polybutylenes, polyurethanes, cellulose acetates, cellulose nitrates, ethylcelluloses, ethylenevinyl alcohols, polyperfluoroalkooxyehtylenes, fluorocarbons, polyketones, polyetherketones, liquid crystal polymers, Nylons, polyethers, polytherimide, polyethersulfone, natural rubbers, synthetic rubbers, acrylics (emulsions or solutions), nitriles, ethylene propylenes, ethylene propylene diene methylenes, polyethylenes, chlorosulfonated polyethylenes, neoprenes, hypalon, ethylene acrylics, viton, acrylonitrile-butadiene acrylate, acrylonitrile-butadiene styrene terpolymer, acrylonitrile-chlorinated polyethylene styrene terpolymer, acrylate maleic anhydride terpolymer, acrylonitrile-methyl methacrylate, acrylonitrile styrene copolymer, acrylonitrile styrene acrylate, bis maleimide, cellulose acetate, cellulose acetate butyrate, cellulose acetate proprionate, cellulose nitrate, cycloolefin copolymer, chlorinated polyethylene, chlorinated polyvinyl chloride, cellulose triacetate, chlorotrifluoroethylene, diallyl phthalate, ethylene acrylic acid copolymer, ethyl cellulose, ethylene chlorotrifluoroethylene, ethylene-methyl acrylate copolymer, ethylene n-butyl acetate, epoxy, ethylene propylene diene monomer rubber, ethylene propylene copolymer rubber, ethylene propylene rubber, expandable polystyrene, ethylene tetrafluoroethylene, ethylene vinyl acetate, ethylene/vinyl acetate copolymer, ethylene vinyl alcohol, fluorinated ethylene propylene, high density polyethylene, high impact polystyrene, high molecular weight high density polyethylene, low density polyethylene, linear low density polyethylene, linear polyethylene, maleic anhydride, methyl methacrylate/ABS copolymer, methyl methacrylate butadiene styrene terpolymer, medium density polyethylene, melamine formaldehyde, melamine phenolic, nitrile butadiene rubber, olefin modified styrene acrylonitrile, phenolic polymers, poly acetic acid, polyamide-imide, polyaryletherketone, polyester alkyd, polyanaline, polyacrylonitrile, polyaryl amide, polyarylsulfone, polubutylene, polybutadiene acrylonitrile, polybutadine, polybenzimidazole, polybutylene napthalate, polybutadiene styrene, polybutylene terephthalate, polycarbonate, polycarbonate/acrylonitrile butadiene styrene blend, polycaprolactone, polycyclohexylene terephthallate, glycol modified polycyclohexyl terephthallate, polymonochlorotrifluoroethylene, polyethylene, polyether block amide or polyester block amide, polyetheretherketone, polyetherimide, polyetherketone, polyetherketone etherketone ketone, polyetherketoneketone, polyethylene naphthalene, polyethylene oxide, polyethersulfone, polyethylene terephthalate, glycol modified polyethylene terephthalate, perfluoroalkoxy, polyimide, polyisoprene, polyisobutylene, polyisocyanurate, polymethactylonitrile, polymethylmethacrylate, polymethylpentene, paramethylstyrene, polyoxymethylene, polypropylene, polyphthalamide, chlorinated polypropylene, polyphthalate carbonate, polyphenylene ether, polymeric polyisocyanate, polyphenylene oxide, polypropylene oxide, polyphenylene sulfide, polyphenylene sulfone, polypropylene terephthalate, polystyrene, polystyrene/polyisoprene block copolymer, polysulfone, polytetrafluoroethylene, polytetramethylene terephthalate, polyurethane, polyvinyl alcohol, polyvinyl acetate, polyvinyl butyryl, polyvinyl chloride, polyvinyl chloride acetate, polyvinylidene acetate, polyvinylidene chloride, polyvinylidene fluoride, polyvinyl fluoride, polyvinyl carbazole, polyvinyl alcohol, polyvinyl pyrrolidone, styrene acrylonitrile, styrene butadiene, styrene butadiene rubber, styrene butadiene styrene block copolymer, styrene ethylene butylene styrene block copolymer, styrene isoprene styrene block copolymer, styrene maleic anhydride copolymer, styrene methyl methacrylate, styrene/a-methyl styrene, styrene vinyl acrylonitrile, urea formaldehyde, ultrahigh molecular weight polyethylene, ultra-low density polyethylene, unsaturated polyester, vinyl acetate, vinyl acetate ethylene, very low density polyethylene, expandable polystyrene, derivatives thereof, and co-polymers thereof.

In a preferred example, the coating comprises one or more of: polyethylene, kapton, polyurethane, polyester, natural rubber, synthetic rubber, hypalon, plastic alloys, PTFE, polyvinyl halides, polyester, neoprene, acrylics, nitrites, EPDM, EP, viton, vinyls, vinyl-acetate, ethylene-vinyl acetate, styrene, styrene-acrylates styrene-butadienes, polyvinyl alcohol, polyvinylchloride, acrylamids, phenolics or a combination thereof.

In some examples, the coating comprises soft carbon. In one example, the coating is a pitch-derived carbon coating. In one example, the pitch-derived carbon coating comprises soft carbon.

According to some examples of the present disclosure, the coating comprises pitch-derived carbon. In some examples, the pitch-derived carbon includes soft carbon. As used herein, the term “soft carbon” refers to amorphous carbon formed by carbonization of pitch. Soft carbon represents the graphitizable nongraphitic carbon with a higher electronic conductivity, whose graphitization degrees and interlayer distance can be tuned by a thermal treatment.

In some examples, the coating is selected from pitch-derived soft carbon, carbon black, and mesitylene-derived spherical carbon.

Without wishing to be bound by theory, pitch-derived carbon coating of the present disclosure greatly hinders the formation of defects and oxygen-containing groups. Pitch-derived carbon coating of the present disclosure, e.g., soft carbon, can withstand the severe volume expansion that occurs upon Si lithiation owing to its high mechanical strength, originating from the long-range graphitic ordering, e.g., crystallinity. Exemplary pitch-derived carbon coatings of the present disclosure contain ordered graphite regions with controllable crystallinity. Without wishing to be bound by theory, controllable crystallinity of the pitch-derived carbon coating imparts excellent electron transfer properties and structural elasticity to improve electrochemical performance. Graphitic ordering of pitch-derived carbon coating can be adjusted with increasing heat treatment temperature in the range of 500-1400° C. Stepwise carbonization can be performed to gradually tune the degree of crystallinity.

In examples of the present disclosure, essentially any method for coating may be used as customary in the art. Examples of suitable coating techniques include but are not limited to: sol-gel coating e.g. coagulation process, knife over roll coating, dip or saturation coating, reverse roll (all forms) coating, direct roll coating, gravure coating, printing rotary screen coating, curtain coating, die coating or extrusion, spray coating, transfer coating, electrostatic coating, brush coating, vapor deposition, flocking, hot knife or hot melt extrusion and methods combining the aforementioned.

In examples of the present disclosure, a coating can be applied on the surface of carbon materials, e.g., carbon aerogel beads, or on the surface of carbon precursor materials, e.g., aerogel, xerogel, cryogel or ambigel materials such as polyimide beads.

In a particular example, an exemplary coating of the present technology (e.g., a polymeric coating, pitch coating, soft carbon coating, pitch-derived carbon coating) can be applied on the surface of aerogel materials (e.g., precursor of carbon aerogel materials prior to a heat treatment step, e.g., carbonization step). In one example, application of such coatings can be accomplished by spraying a molten coating material, a coating material in solution, a coating material in suspension or combinations thereof through a nozzle or a similar device. U.S. Pat. Nos. 5,180,104, 5,102,484, 5,683,037, 5,478,014, 5,687,906, 6,488,773, 6,440,218 teach spray nozzles, spray guns and other devices that can be used for the in this embodiment, all hereby incorporated by reference. In yet another example, a coating is applied via a dip coating method.

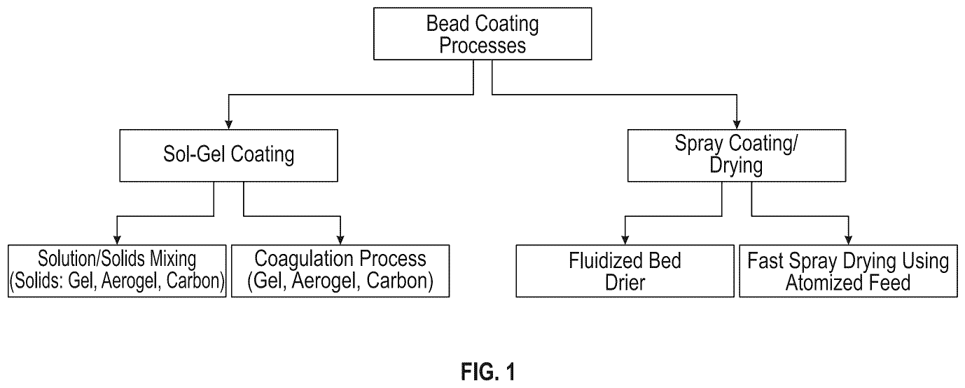

In another example, an exemplary coating is applied via sol-gel method, wherein the coating material dissolved or dispersed in solution coagulates on the surface of aerogel materials (e.g., aerogel beads) with the help of a coagulant solvent or a coagulant agent. In some examples, the coagulant solvent comprises DMF, DMAC, DMSO, methanol, ethanol, isopropyl alcohol, water or mixture thereof. In another example, the coagulant solvent comprises aqueous electrolyte solutions. Exemplary bead coating processes that is suitable for applying to the surface of aerogel materials (e.g., aerogel beads) of the present disclosure are shown in FIG. 1.

In one example, the exemplary coating material and the exemplary aerogel materials (e.g., aerogel beads) of present disclosure are dispersed in a dispersion medium (e.g., silicon oil) to prepare an emulsion (e.g., slurry), and then the emulsion is contacted with a coagulation solvent. Without wishing to be bound by the theory, when the emulsion is contacted with a coagulation solvent, the coating material coagulates or solidifies, almost instantly, around the aerogel materials thereby forming solid coating layer on the surface of aerogel material. That is, addition of a coagulation solvent leads to formation of coated aerogel materials. In one example, the time required for adding the coagulation solvent to the emulsion (e.g., slurry of coating material and aerogel material in a dispersion medium) is at least 150 seconds, at least 600 seconds, at least 20 minutes, at least 30 minutes, at least 60 minutes, at least 2 hours, at least 3 hours, at least 6 hours, at least 12 hours, at least 24 hours, or at least 48 hours.

In multiple examples, the coagulation solvent is miscible with the solvent (e.g., dispersion medium) used to prepare the coating-aerogel material solution or slurry.

In a particular example, the exemplary coated aerogel materials of the present technology (e.g., a polymer coated, pitch coated, carbon coated aerogel beads) further undergo at least one heat treatment step (e.g., a softening process, a carbonization step).

As discussed above, the surface of exemplary aerogel materials of the present technology can be coated using any method for coating known as customary in the art (e.g., spray coating, coagulation process). A coating of the present technology can also be adhered directly on the surface of the carbon-based core (e.g., carbon aerogel materials). That is, no intermediate layer is deposited or formed between the core and the coating. In multiple examples, carbon aerogel materials are obtained by processing (e.g., carbonization) aerogel materials prior to applying or supplying the coating material. As a result, a carbonization step is not required after application of the coating material.

In a particular example, an exemplary coating (e.g., a polymeric coating, pitch coating, soft carbon coating, pitch-derived carbon coating) can be applied on the surface of carbon aerogel materials. That is, any carbonization step for the aerogel occurred prior to application of the exemplary coating. In one example, application of such coatings can be accomplished by spraying a molten coating material, a coating material in solution, a coating material in suspension or combinations thereof through a nozzle or a similar device. U.S. Pat. Nos. 5,180,104, 5,102,484, 5,683,037, 5,478,014, 5,687,906, 6,488,773, 6,440,218 teach spray nozzles, spray guns and other devices that can be used for the in this embodiment, all hereby incorporated by reference. In yet another example, a coating is applied via a dip coating method.

In another example, a coating is applied via sol-gel method, wherein the coating material dissolved or dispersed in solution coagulates on the surface of carbon aerogel materials with the help of a coagulant solvent. In some examples, the coagulant solvent comprises DMF, DMAC, DMSO, water or mixture thereof. Exemplary bead coating processes that is suitable for applying to the carbon-based core of the present disclosure are shown in FIG. 1.

The thickness of the coating can vary depending on the end-use and properties of the selected polymers. In one example, the thickness of the coating is less than or equal to about 2,500 nm, or a thickness between about 100 nm and about 2,000 nm, or a thickness of about 200 nm to 500 nm.

For certain applications it is desired to employ a flexible coating such that once coated the flexural modes of the carbon aerogel or aerogel material (or aerogel composite) are not significantly hindered. As such, polymeric coatings with elastic behavior or low stiffness are preferred.

In another example, the surface of the porous carbon-based e.g., aerogel material is modified prior to coating. Surface treatment methods include plasma treatment, corona treatment, or other chemical modifications. This procedure may aid in deposition of the desired coating for instance to achieve for example better deposition of the coating, more uniform thickness or better adhesion to the core.

Once applied, a coating together with the composite material may also be subjected to other processing steps such as drying, curing, carbonization and sintering for reasons such as solvent removal, better adhesion to the core improved mechanical properties and many others. One non-limiting mode of practicing embodiments of the present disclosure involves a motorized conveyor along with one or more spraying systems and one or more temperature treatment units preferably ovens and other mechanical apparatuses to automate the process in an industrial environment. The carbon-based core is fed into the system through the moving conveyor element which takes the core to a spraying system. Spraying system may consist of one or more spray heads whose spray characteristics can be individually controlled. The heat treatment units such as infrared or UV ovens provide the curing/drying to the coating. Spraying and heat treatment units can be located consecutively or in any combinations to provide the desired thickness and finish on the coated core. When solvents are used in the spraying process, appropriate equipment such as hoods and VOC reduction apparatuses may be used.

In some examples, the coating comprises an electrically isolating material e.g., non-conducting material.

In some examples, the coating comprises an electrically conducting material. The electrically conducting material e.g., carbon can be formed from a precursor of an electrically non-conducting material e.g., a polymer. In another example, the electrically conducting material is formed from a precursor of a first electrically conducting material e.g., a metal or a transition metal.

The coating of the present technology is metal ion and/or metal atom permeable. The coating is also impermeable to fluids.

In some examples, permeability of the coating depends on the porosity of the coating e.g., pore size, pore volume, or combination thereof.

In some designs, the coating may be generally uniform, while in other designs it may have a non-uniform composition that changes gradually with radial distance (e.g., from an inner surface to an outer surface).

In some examples, the coating may comprise a plurality of layers. For example, the plurality of layers may comprise an outer layer formed from an electrical insulator material for preventing electrochemical reduction of the aqueous metal-ion electrolyte on the anode or preventing electrochemical oxidation of the aqueous metal-ion electrolyte on the cathode. This may be achieved by the insulative outer layer accommodating a portion of the voltage drop between the anode and cathode, thereby reducing the voltage drop across the aqueous metal ion electrolyte. In other examples, the plurality of layers may comprise an electrically conductive layer for electrically connecting the active material particles, an interfacing layer for enhancing uniformity or adhesion of another layer, a mechanically stable layer for enhancing mechanical stability of the conformal, metal—ion/and or metal atom permeable coating, or a supplemental protection layer for preventing electrochemical reduction of the aqueous metal—ion electrolyte on the anode or preventing electrochemical oxidation of the aqueous metal—ion electrolyte on the cathode.

### Lithium-Ion Batteries

A basic example of a lithium-ion battery includes: a cathode; an anode in electrical communication with the cathode; an electrolyte disposed between the anode and the cathode; and a separator also disposed between the anode and the cathode.

The electrolytes are ionically conductive materials and may include solvents, ionic liquids, metal salts, ions such as metal ions or inorganic ions, polymers, ceramics, and other components. An electrolyte may be an organic or inorganic solid or a liquid, such as a solvent (e.g., a non-aqueous solvent) containing dissolved salts. Non-aqueous electrolytes can include organic solvents, such as, cyclic carbonates, linear carbonates, fluorinated carbonates, benzonitrile, acetonitrile, tetrahydrofuran, 2-methyltetrahydrofuran, γ-butyrolactone, dioxolane, 4 methyldioxolane, N,N-dimethylformamide, N,N-dimethylacetamide, N,N-dimethylsulfoxide, dioxane, 1,2-dimethoxyethane, sulfolane, dichloroethane, chlorobenzene, nitrobenzene, diethyleneglycol, dimethylether, and mixtures thereof. Example salts that may be included in electrolytes include lithium salts, such as LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y-1}SO₂), (where χ and y are natural numbers), LiCl, LiI, and mixtures thereof. In some examples, the liquid molecules comprise an electrolyte solvent (an electrolyte). The electrolyte solvent of the present disclosure can be selected from any of the suitable electrolyte described above. Particularly, the electrolyte is selected from ethylene carbonate (EC), diethyl carbonate (DEC), dimethyl carbonate (DMC), fluoroethylene carbonate (FEC), fluorinated ether (F-EPE), 1,3-dioxolane (DOL), dimethoxyethane (DME), or combination thereof.

The separators are typically thin, porous or semi-permeable, insulating films with high ion permeabilities. The separators can be composed of polymers, such as olefin-based polymers (e.g., polyethylene, polypropylene, and/or polyvinylidene fluoride). If a solid polymer electrolyte is used as the electrolyte, the solid polymer electrolyte may also act as the separator.

The anodes are composed of an active anode material that takes part in an electrochemical reaction during the operation of the battery. Example anode active materials include elemental materials, such as lithium; alloys including alloys of Si and Sn, or other lithium compounds; and intercalation host materials, such as graphite. By way of illustration only, the anode active material may include a metal and/or a metalloid alloyable with lithium, an alloy thereof, or an oxide thereof. Metals and metalloids that can be alloyed with lithium include Si, Sn, Al, Ge, Pb, Bi, and Sb. For example, an oxide of the metal/metalloid alloyable with lithium may be lithium titanate, vanadium oxide, lithium vanadium oxide, SnO₂, or SiOₓ (0<x<2).

The cathodes are composed of an active cathode material that takes part in an electrochemical reaction during the operation of the battery. The active cathode materials may be lithium composite oxides and include layered-type materials, such as LiCoO₂; olivine-type materials, such as LiFePO₄; spinel-type materials, such as LiMn₂O₄; and similar materials. The spinel-type materials include those with a structure similar to natural spinal LiMn₂O₄, that include a small amount nickel cation in addition to the lithium cation and that, optionally, also include an anion other than manganate. By way of illustration, such materials include those having the formula LiNi_{(0.5-x)}Mn_{1.5}MₓO₄, where 0≤x≤0.2 and M is Mg, Zn, Co, Cu, Fe, Ti, Zr, Ru, or Cr.

Within the context of the present disclosure, the term “cycle life” refers to the number of complete charge/discharge cycles that an anode or a battery (e.g., LIB) is able to support before its capacity falls under about 80% of its original rated capacity. Cycle life may be affected by a variety of factors, for example mechanical strength of the underlying substrate (e.g., carbon aerogel) and maintenance of interconnectivity of the aerogel. It is noted that these factors actually remaining relatively unchanged over time is a surprising aspect of certain examples of the present disclosure. Cycle life may be determined by methods known in the art, for example including, but not limited to, cycle testing, where battery cells are subject to repeated charge/discharge cycles at predetermined current rates and operating voltage. Within the context of the present disclosure, measurements of cycle life are acquired according to this method, unless otherwise stated. Energy storage devices, such as batteries, or electrode thereof, can have a cycle life of about 25 cycles or more, 50 cycles or more, 75 cycles or more, 100 cycles or more, 200 cycles or more, 300 cycles or more, 500 cycles or more, 1000 cycles or more, or in a range between any two of these values.

The present disclosure includes an electrical energy storage device with at least one anode comprising the composite material of present technology as described herein, at least one cathode, and an electrolyte with lithium ions. The electrical energy storage device can have a first cycle efficiency (i.e., a cell's coulombic efficiency from the first charge and discharge) of at least 10%, 20%, 30%, 40%, 50%, 60%, 70%, any intervening value (e.g., 65%) or in a range between any two of these values (e.g., ranges from about 30% to about 50%). As previously described herein, reversible capacity can be at least 150 mAh/g. The at least one cathode can be selected from the group consisting of conversion cathodes such as lithium sulfide and lithium air, and intercalation cathodes such as phosphates and transition metal oxides.

According to different examples, the composite materials of the present disclosure may be applied to both the positive electrode and the negative electrode of electrochemical energy storage devices, or to the electrodes individually (either the positive electrode or the negative electrode). In various examples, a cathode, anode, or solid-state electrolyte material is coated with the composite materials of the present technology.

### EXAMPLES

The following examples are included to demonstrate preferred embodiments of the technology. However, those of skill in the art should, in light of the present disclosure, appreciate that many changes can be made in the specific examples which are disclosed and still obtain a like or similar result without departing from the spirit and scope of the technology.

### Example 1: Polyacrylonitrile (PAN) Fiber Fabrication by Coagulation Process

Dry spinning or wet-spinning methods are typically used to fabricate PAN fibers. In this example, the wet-spinning route, which involves the extrusion of PAN solution into a bath containing a coagulant (such as, e.g., DMSO or DMAC) and non-solvent (e.g., water) was followed.

In the coagulation bath, the fibers started coagulating slowly until they formed a dense structure. The process of coagulation depends on two diffusion mechanisms: diffusion of the solvent out of the fibers into the bath and the diffusion of the non-solvent from the bath into the fibers. Both mechanisms happen simultaneously. The balance of these two processes lead to precipitation of the PAN into fibrillar form. Coagulation can be influenced by various reaction parameters such as polymer composition, coagulation bath composition, coagulation bath temperature.

### Example 2: Preparation of PAN Coated Carbon/Silicon Beads by Coagulation

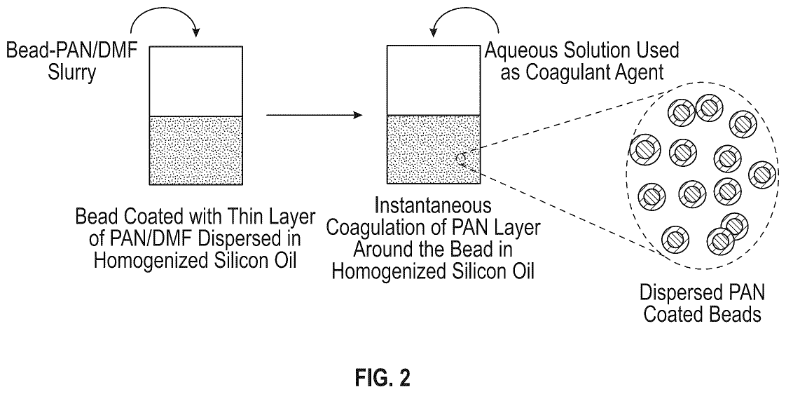

In a clean beaker, a slurry of PAN solution and C/Si beads was prepared (FIG. 2). The slurry was mixed under mechanical mixer for 5 minutes-16 hours, depending on the PAN content (e.g., viscosity) in solution. Then, the slurry was poured in a homogenized dispersant medium (e.g., silicon oil, mineral oil, hydrocarbon) to assure a better dispersion/scattering of the beads in the dispersant medium. In FIG. 2, the dispersant medium used was silicon oil. The homogenizer mixer was set at speed of 3,000-9,000 rpm depending on the viscosity of the dispersant medium. Once, good dispersion of C/Si beads was achieved, where C/Si beads are covered with a layer of PAN solution, a coagulant solvent (aqueous solution, e.g., H₂O or EtOH/H₂O mixture) was added to the homogenized bath while mixing the solution. When the coagulant solvent came in contact with the PAN solution layer covering each C/Si bead, the PAN coagulates or solidifies, instantly, around the beads, thereby forming solid PAN coating layer on C/Si beads.

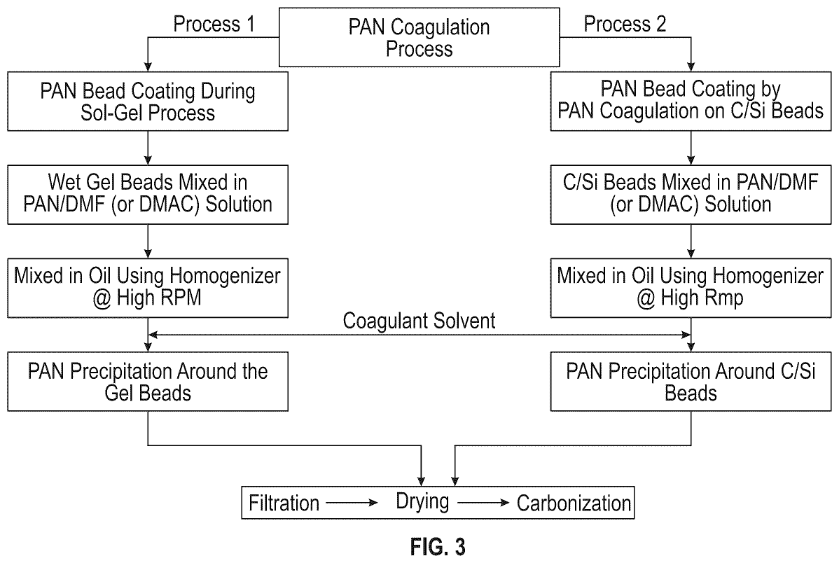

The bead (e.g., aerogel beads) coating by PAN coagulation was performed by two different routes. As shown in FIG. 3, process 1 describes the route for coating wet polyimide/silicon beads (wet beads means freshly prepared by sol-gel process), while process 2 describes the same route for coating carbonized beads (C/Si beads). Both processes use coagulation in homogenized oil medium to assure a better bead dispersion and avoid bead agglomeration. At the end, the beads are filtered, rinsed, dried (supercritically, subcritically or dried at ambient conditions), and carbonized. The beads in process 2 underwent two carbonization cycles.

There are at least two different routes for the carbonization of PAN coated C/Si (or polyimide/Si) beads. In route 1, a heat treatment at 300° C. under air, for full cyclization of PAN, for a period varying from 1-6 hours, followed by carbonization at temperature above 650° C. under inert gas for a period varying from 2-5 hours is applied. In route 2, direct carbonization at temperature above 650° C., under inert gas, for a period varying from 2-5 hours is utilized.

### Example 2.1 Preparation of PAN Coated Carbon/Silicon Beads by Coagulation Through Process 1

Polyimide/Silicon beads (silicon available from Evonik Industries AG, North Rhine-Westphalia, Germany) were prepared by sol-gel route, using DMAC as solvent and 100 cSt (centi-Stoke) silicon oil as dispersant medium for bead fabrication. Once rinsed with ethanol several times, the cake or the bead gel was divided into two equal amounts (˜75 g each). One part of the sample was supercritically dried with CO₂ (i.e., uncoated beads, uncoated #1) and the other part (wet bead gel) was coated with PAN using process 1, as described above and shown in FIG. 3.

A 5% PAN solution was prepared by dissolving 5 g of PAN in 95 g of DMAC. Then, the solution was mixed for 6 hrs. Next, 75 grams of wet bead gel were mixed in the PAN solution for 20-30 minutes, until a homogeneous slurry was obtained. The slurry was poured in a silicon oil bath mixed by homogenizer at 7500 rpm and mixed for 2 minutes. An ethanolic solution (50/50; EtOH/H₂O) was added slowly to the system while mixing. The appearance of the mixture turned from black to grey color, indicating the coagulation of the PAN. Once the beads were coated, they were separated from the oil, rinsed with ethanol (and heptane to remove the residual oil), and filtered. The coated beads were also supercritically dried same as the uncoated bead gel.

The obtained PAN coated aerogel beads were divided into 2 samples: one sample (sample A) was heat-treated at 300° C. at air then carbonized at 650° C. under N₂ and the other sample (sample B) was carbonized directly at 1050° C. under N₂. Table 1 summarizes the conditions of carbonization and structural properties of the three different beads.

TABLE 1
Uncoated and PAN coated C/Si beads fabricated by process 1.

| | PAN | Carbonization | S_{BET} | S (micro.) | Pore vol. | % Si by |
|---|---|---|---|---|---|---|
| Sample ID | Coating | conditions | (m²/g) | (m²/g) | (cc/g) | TGA |
| Uncoated #1 | No | 1050° C./N₂/2 hr | 291 | 76 | 1.28 | 38.59 |
| A | Yes | 300° C./Air/2 hr | 237 | 75 | 1.07 | 30.93 |
| | | 650° C./N₂/4 hr | | | | |
| | | (route 1) | | | | |
| B | Yes | 1050° C./N₂/2 hr | 166 | 71 | 0.78 | 34.96 |
| | | (route 2) | | | | |

Coated beads show a decrease of the surface area. Referring the Table 1, the surface area of uncoated #1 is greater than the two coated samples. That is, sample A and B appears to include a coating that covers at least part of available surface area. For example, sample B that underwent route 2 exhibits a surface area˜43% lower than that of the uncoated sample (uncoated #1). The data suggests coating of at least a part of the surface area of uncoated sample. Decrease in the surface area of the beads after coating suggests that PAN coating may have desired porosity properties in terms of its permeability. For example, when phenolic resin was used as a coating material, the surface area of the system increased, suggesting that phenolic resin may be undesirable as a coating material for fluid impermeability.

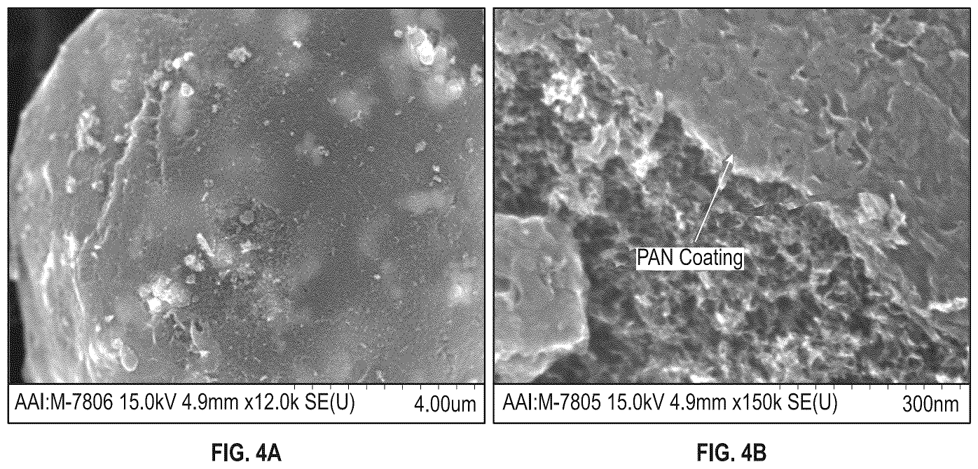

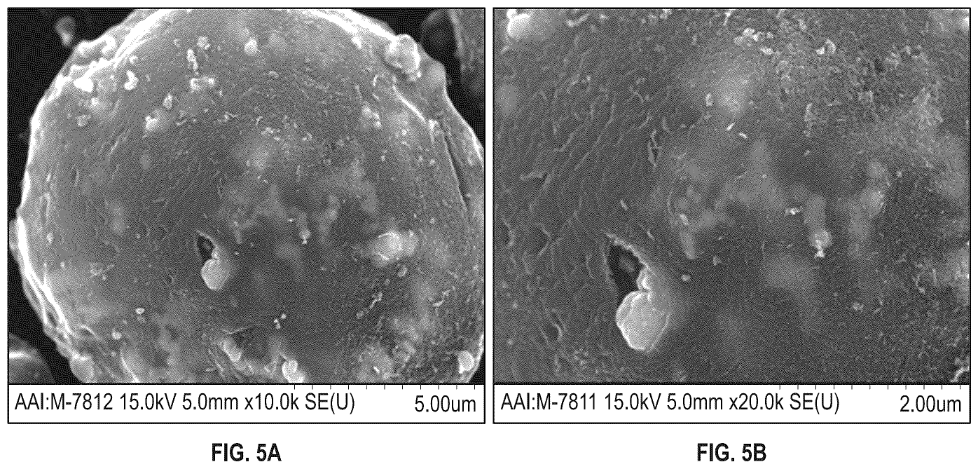

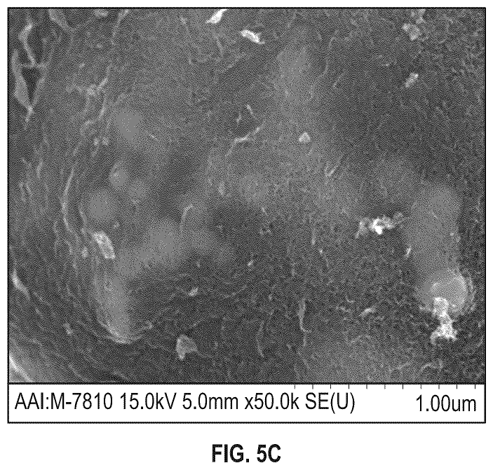

SEM pictures shown in FIGS. 4A and 4B and FIGS. 5A-5C illustrate the presence of carbon coating layer on C/Si beads. Therefore, the process of PAN coating by coagulation appears to be promising for further improvement and optimization. However, this route (process 1) shows some imperfection and some uncoated sections on the beads. Temperature of carbonization (route 1: 300° C./air then 650° C./N₂ versus route 2: 1050° C./N₂) does not seem to affect the quality of the coating. However, the temperature may directly impact on the porosity (surface area) and probably battery performance.

### Example 2.2 Preparation of PAN Coated Carbon/Silicon Beads by Coagulation Through Process 2

In this example, carbon aerogel beads (uncoated #2) were used. These beads developed a high surface area of 440 m²/g. To coat the beads, 3.53 grams of carbon aerogel (uncoated #2) were mixed with 26 g of PAN solution (5% wt PAN in DMAC) for 20-30 min, until a homogenous slurry was obtained. The slurry was poured in silicon oil bath mixed by homogenizer at 7500 rpm and mixed for 2 minutes. An ethanolic solution (50/50: EtOH/H₂O) was added slowly to the system while mixing. The appearance of the mixture turned from black to grey color, indicating the coagulation of the PAN. Once the beads were coated, they were separated from the oil, rinsed with ethanol (and heptane to remove the residual oil), and filtered. The carbon-PAN coated beads were supercritically dried. It is noted that other drying methods could be used in other examples. For example, the beads could also have been subcritically dried or dried at ambient conditions to obtain xerogels or ambigels.

The obtained PAN coated aerogel beads were divided into 2 sample: one sample was heat-treated at 300° C. at air then carbonized at 650° C. under N₂ (sample C) and the other part was carbonized directly at 1050° C. under N₂ (sample D). Table 2 summarizes the conditions of carbonization and structural properties of the three different beads.

Since the starting material (carbon aerogel bead) is a silicon free material, the surface area of the PAN coated carbon beads is higher than the PAN coated carbon/silicon beads characterized previously in process 1. Presence of silicon in a carbon structure greatly contributes in the decrease of the surface area of the system, i.e., the higher the silicon content, the lower the surface area. Coated beads show a decrease of the surface area. Referring the Table 2, the surface area of uncoated #2 is greater than the two coated samples. That is, sample C and D appears to include a coating that covers at least part of available surface area. For example, sample C that underwent route 2 exhibits a surface area˜25% lower than that of the uncoated sample (uncoated #2). The data suggests coating of at least a part of the surface area of uncoated sample.

TABLE 2
Uncoated and PAN coated Carbon beads fabricated by process 2.

| | PAN | Carbonization | S_{BET} | S (micro.) | Pore vol. | % Si by |
|---|---|---|---|---|---|---|
| Sample ID | Coated | conditions | (m²/g) | (m²/g) | (cc/g) | TGA |
| Uncoated #2 | No | 1050° C./N₂/2 hr | 440 | 84 | 1 | — |
| C | Yes | 300° C./Air/2 hr | 337 | 30 | 0.82 | — |
| | | 650° C./N₂/4 hr | | | | |
| | | (route 1) | | | | |
| D | Yes | 1050° C./N₂/2 hr | 314 | 44 | 0.78 | — |
| | | (route 2) | | | | |

The increase of temperature of carbonization of PAN coated carbon aerogel to 1600-2200° C., could further decrease the surface area of the system, by graphitization of the PAN layer.

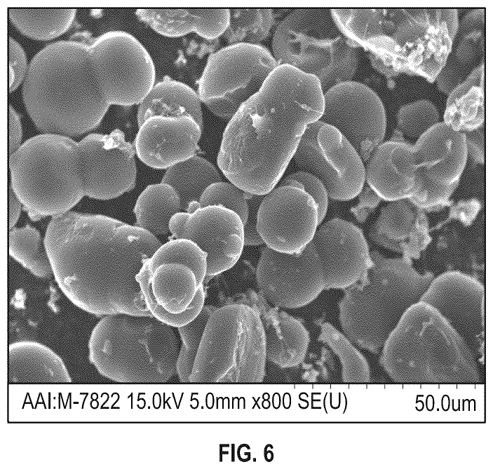

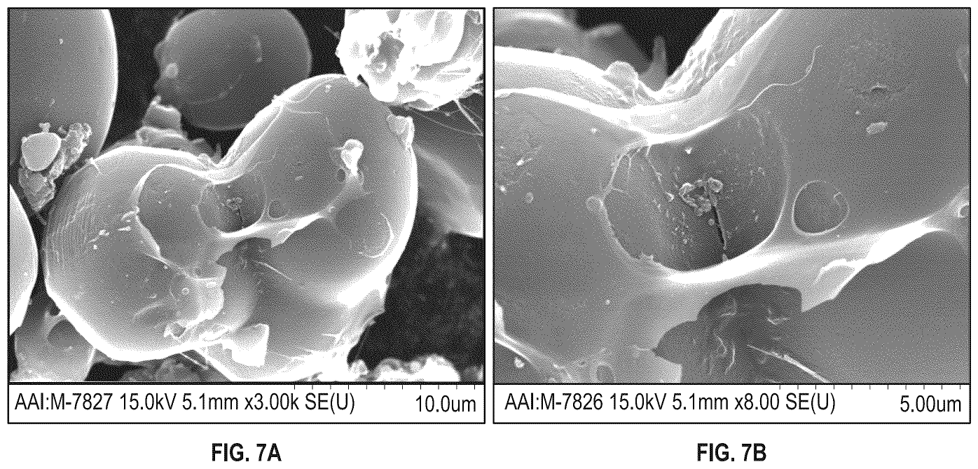

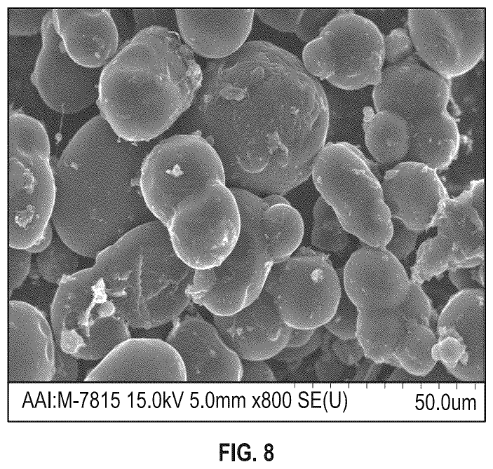

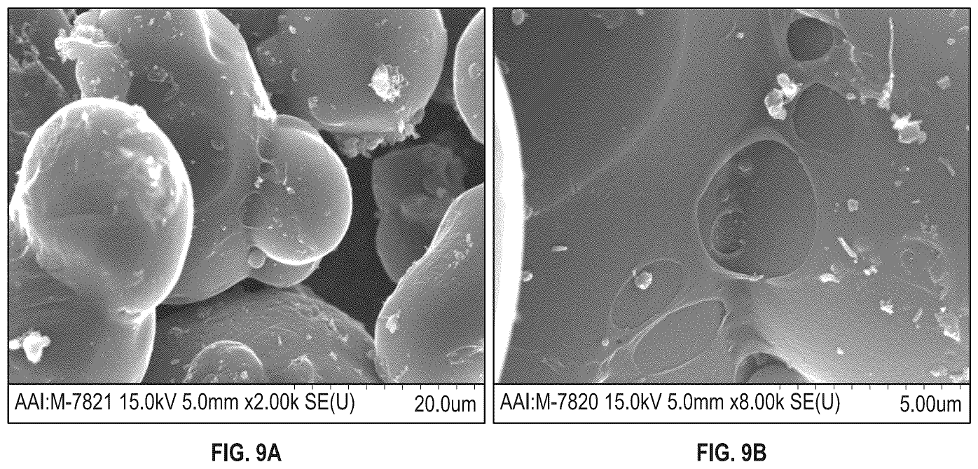

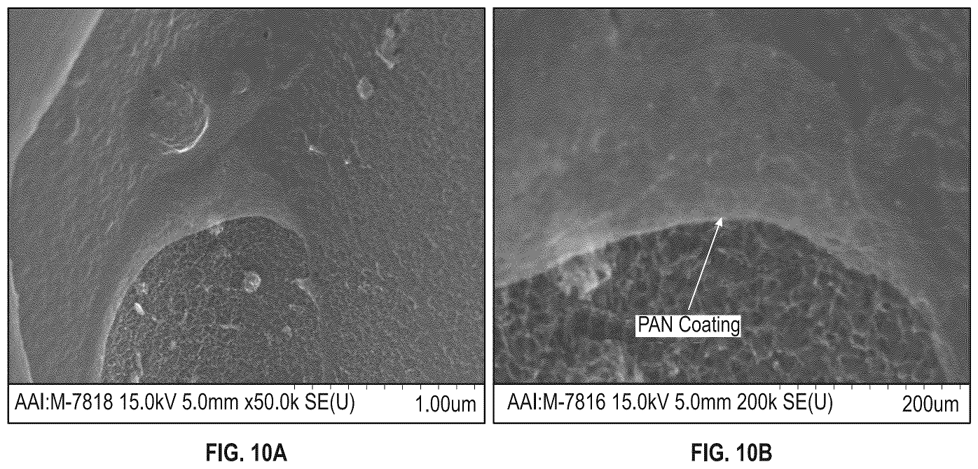

SEM pictures (FIGS. 6-10B) show fully coated beads (i.e., PAN coats entire bead). Regardless of the temperature profile of carbonization, both samples, C and D, illustrate a PAN coating on the surface of the entirety of the beads. The presence of PAN coating is well demonstrated in the high magnification SEM pictures (FIGS. 7A, 7B, 9A, 9B, 10A and 10B). Particularly in FIGS. 10A and 10B, shows a PAN layer covering the fibrillous structure of the carbon aerogel. This coating appears to be free of imperfections.

### Example 3: Solution Based-Pitch Coating Directly on PI (Polyimide) Beads

Solution based-pitch coating was performed on the surface of the polyimide (PI) gel beads, which had been prepared with an emulsion process. After obtaining PI beads, the PI beads were further polymerized via a thermal imidization in a furnace (250-400° C., 2 hours). Without thermal imidization, dimethylacetamide (DMAC) that was used in the next step might dissolve polyamic acid (PAA) present in the PI gel beads. First, after dissolving the pitch in the DMAC solvent, the DMAC/pitch slurry was stirred for a few minutes, then stirred while adding the PI gel beads, and stirred at over 100 RPM for 30 minutes. Then, the temperature of the mixture was elevated between 50° C.-120° C., and the mixture was stirred at under 100 RPM overnight to evaporate DMAC. When the solvent (e.g., DMAC) was dried, the pitch coated PI beads were gently grinded with mortar and pestle.

The pitch-coated PI beads were then heated to 250-300° C., and the temperature was maintained for 2 hours for softening process. The softening process enables transition of solid pitch to a viscous liquid so that pitch can be coated uniformly. The pitch-coated PI beads further underwent a carbonization process at 1050° C. for 2 hours. In the carbonization process, the PI bead turns to a carbon-based core and the pitch coating turns to a soft carbon coating layer. The graphitization degrees and interlayer distance of the pitch coating were tuned in the carbonization process.

### Example 4: Solution Based-Pitch Coating Directly on Carbon Beads

Solution based-pitch coating was performed on the surface of the carbon beads. After obtaining PI beads, the PI gel beads were underwent a carbonization process at 1050° C. for 2 hours to obtain a carbon-based core, e.g., carbon beads. First, after dissolving the pitch in the DMAC solvent to obtain a DMAC/pitch slurry, the DMAC/pitch slurry was stirred for a few minutes, then stirred while adding the carbon beads, and stirred at over 100 RPM for 30 minutes. Then, the temperature of the mixture was elevated between 50° C.-120° C., and the mixture was stirred at under 100 RPM overnight to evaporate DMAC. When the solvent (e.g., DMAC) was dried, the pitch coated carbon beads were gently grinded with mortar and pestle.

The pitch-coated carbon beads were then heated to 250-300° C., and the temperature was maintained for 2 hours for softening process. The softening process enables transition of solid pitch to a viscous liquid so that pitch can be coated uniformly. The pitch-coated carbon beads further underwent a carbonization process to tune the graphitization degree and interlayer distance of the pitch coating (1050° C. for 2 hours).

Table 3 summarizes the structural properties of solution based-pitch coated carbon beads as well as first cycle efficiencies (FCE) of an electrical storage device (e.g., Li-ion battery) in which the pitch coated PI and carbon beads are applied.

TABLE 3
Uncoated (control) and pitch coated beads fabricated by examples 3 and 4.

| | | | | 1^{st} | 50^{th} |
|---|---|---|---|---|---|
| | BET | Particle | | delithiation | delithiation |
| Sample Name | (m²/g) | size (μm) | FCE | (mAh g⁻¹) | (mAh g⁻¹) |
| Uncoated carbon beads - | 24.16 | D10: 9.98 | 52.85% | 342.00 | 256.37 |
| Sample AX | | D50: 18.92 | | | |
| | | D90: 56.95 | | | |
| Carbon beads obtained by | 1.41 | D10: 9.96 | 58.93% | 375.28 | 272.82 |
| example 3 - Sample BX | | D50: 17.90 | | | |
| | | D90: 36.93 | | | |
| Uncoated carbon beads - | 0.797 | D10: 5.06 | 64.5% | 288.0 | 216.0 |
| Sample CX | | D50: 7.97 | | | |
| | | D90: 12.17 | | | |
| Carbon beads obtained by | 0.060 | D10: 4.99 | 69.6% | 302.0 | 222.2 |
| example 4 - Sample DX | | D50: 7.67 | | | |
| | | D90: 11.46 | | | |

Solution based-pitch coating were also applied to Si/C composite beads. Protocols similar to examples 3 and 4 have been utilized to obtain pitch coated Si/C composite beads. The effect of softening and carbonatization step was investigated.

Table 4 summarizes the structural properties of solution based-pitch coated Si/C composite beads as well as first cycle efficiencies (FCE) of an electrical storage device (e.g., Li-ion battery) in which the pitch coated Si/C beads are applied.

The results presented in Table 4 shows that pitch coated Si/C beads provides higher FCE and cycle efficiencies compared to pitch coated carbon beads presented in Table 3. The pitch coated Si/C composite particles that underwent softening and carbonization step were found to be more efficient compared to the pitch coated Si/C composite particles that were not carbonized. It seems that softening process contributes improved electrochemical performance of the electrode. Without wishing to be bound by the theory, this may be because softening process enables uniform coating of the beads with pitch.

TABLE 4
Uncoated (control) and pitch coated Si/C beads fabricated by solution
based-pitch coating with and without softening and carbonization step

| | | | | 1^{st} | 50^{th} |
|---|---|---|---|---|---|
| | BET | Particle | | delithiation | delithiation |
| Sample Name | (m²/g) | size (μm) | FCE | (mAh g⁻¹) | (mAh g⁻¹) |
| Control Si /C composite beads | 8.232 | D10: 8.02 | 80.0% | 1426.1 | 711.4 |
| | | D50: 14.00 | | | |
| | | D90: 22.96 | | | |
| Solution based-pitch coated | 8.534 | D10: 6.24 | 82.5% | 1406.9 | N/A |
| Si/C beads without softening | | D50: 10.51 | | | |
| and carbonization step | | D90: 16.19 | | | |
| Solution based-pitch coated | 5.859 | D10: 4.03 | 83.9% | 1526.0 | 726.1 |
| Si/C beads with softening and | | D50: 6.47 | | | |
| carbonization step | | D90: 9.66 | | | |

### Example 5: Spray Drying Based-Pitch Coating Directly on PI (Polyimide) Beads

Spray drying based-pitch coating was performed on the surface of the polyimide (PI) gel beads, which had been prepared with an emulsion process. After obtaining PI beads, the PI beads were further polymerized via a thermal imidization in a furnace (250-400° C., 2 hours). Without thermal imidization, dimethylacetamide (DMAC) that was used in the next step might dissolve polyamic acid (PAA) present in the PI gel beads. First, after dissolving the pitch in the DMAC solvent, the DMAC/pitch slurry was stirred for a few minutes, then stirred while adding the PI gel beads, and stirred at over 100 RPM for 30 minutes.

Then, the temperature of the mixture was elevated to 160° C. to dry the beads. This spray drying step enables uniform pitch coating on the PI beads. The pitch-coated PI beads were then heated to 250-300° C., and the temperature was maintained for 2 hours for softening process, e.g., process of obtaining soft carbon from pitch.

Softening process enables transition of solid pitch to a viscous liquid so that pitch can be coated uniformly. The pitch-coated carbon beads were further underwent a carbonization process (1050° C. for 2 hours) in which the underlying PI core beads transformed to carbon and the pitch coating transforms into soft carbon.

Table 5 summarizes the structural properties of spray based-pitch coated carbon beads as well as first cycle efficiencies (FCE) of an electrical storage device (e.g., Li-ion battery) in which the pitch coated Si/C beads were applied.

TABLE 5
Uncoated (control) and pitch coated beads fabricated by example 5

| Sample | BET | Particle | |
|---|---|---|---|
| Name | (m²/g) | size (μm) | FCE |
| Control | 24.16 | D10: 9.98 | 52.85% |
| | | D50: 18.92 | |
| | | D90: 56.95 | |
| Carbon beads | 10.59 | D10: 11.03 | 58.29% |
| obtained by | | D50: 19.91 | |
| example 5 | | D90: 75.21 | |

As presented in Table 5, coulombic efficiencies from the first charge and discharge (FCE) of the electrodes using pitch coated carbon beads were relatively higher (improved) compared to the electrodes using control beads.

### Example 6: Spray Drying Based-Pitch Coating Directly on Carbon Beads

Spray drying based-pitch coating was performed on the surface of the carbon beads. After obtaining PI beads, the PI gel beads were underwent a carbonization process at 1050° C. for 2 hours to obtain a carbon-based core, e.g., carbon beads. First, after dissolving the pitch in the DMAC solvent to obtain a DMAC/pitch slurry, the DMAC/pitch slurry was stirred for a few minutes, then stirred while adding the carbon beads, and stirred at over 100 RPM for 30 minutes.

Then, the temperature of the mixture was elevated to 160° C. to dry the beads. This spray drying step enables uniform pitch coating on the carbon beads. The pitch-coated carbon beads were then heated to 250-300° C., and the temperature was maintained for 2 hours for softening process, e.g., process of obtaining soft carbon from pitch.

Softening process enables transition of solid pitch to a viscous liquid so that pitch can be coated uniformly, and graphitization degrees and interlayer distance can be tuned. The pitch-coated carbon beads were further underwent a carbonization process (1050° C. for 2 hours).

While this disclosure has been particularly shown and described with reference to example embodiments thereof, it will be understood by those skilled in the art that various changes in form and details may be made therein without departing from the scope of the technology encompassed by the appended claims.

1-57. (canceled)

58. A composite material for use in an electrical energy storage system, the composite material comprising:
a. a carbon-based core having a porous exterior surface, the carbon-based core comprising a carbon-based aerogel, a carbon-based xerogel, a carbon-based ambigel, a carbon-based aerogel-xerogel hybrid material, a carbon-based aerogel-ambigel hybrid material, a carbon-based aerogel-ambigel-xerogel hybrid material, or combinations thereof; and
b. a carbon-based coating on at least a portion of the porous exterior surface of the carbon-based core, wherein the coating is (i) substantially permeable to at least one type of metal ions or metal atoms, and (ii) substantially impermeable to liquids.

59. The composite material of 58, wherein the liquids comprise an electrolyte solvent.

60. The composite material of 59, wherein the electrolyte solvent is selected from ethylene carbonate (EC), diethyl carbonate (DEC), dimethyl carbonate (DMC), fluoroethylene carbonate (FEC), fluorinated ether (F-EPE), 1,3-dioxolane (DOL), dimethoxyethane (DME), or combination thereof.

61. The composite material of 58, wherein at least one type of metal ions are lithium ions and at least one type of metal atoms are lithium atoms.

62. The composite material of claim 58, wherein the coating has a thickness of less than or equal to about 2,500 nm.

63. The composite material of claim 58, wherein the coating has a thickness between about 100 nm and about 2,000 nm.

64. The composite material of claim 58, wherein the coating has a thickness of about 200 nm to 500 nm.

65. The composite material of claim 58, wherein the coating extends into the porous exterior surface of the carbon-based core for less than or equal to about 2,500 nm.

66. The composite material of claim 58, wherein the coating extends into the porous exterior surface of the carbon-based core between about 100 nm and about 2,000 nm.

67. The composite material of claim 58, wherein the coating extends into the porous exterior surface of the carbon-based core about 200 nm to about 500 nm.

68. The composite material of claim 58, wherein the coating is continuous on at least a portion of the porous exterior surface of the core.

69. The composite material of claim 58, wherein the coating is continuous on at least 70% of the porous exterior surface.

70. The composite material of claim 58, wherein the coating is continuous on at least at least 90% of the porous exterior surface.

71. The composite material of claim 58, wherein the coating is continuous on at least at least 95% of the porous exterior surface.

72. The composite material of claim 58, wherein the carbon-based coating comprises a carbonized polymer selected from the group consisting of polyacrylonitriles (PANs), polymethyl methacrylate (PMMA), polyimides, polyamides, and derivatives thereof.

73. The composite material of claim 72, wherein the coating comprises carbonized polyacrylonitrile (PAN).

74. The composite material of claim 58, wherein the carbon-based coating derives from pitch.

75. The composite material of claim 58, wherein the coating penetrates into the pores of the carbon-based core.

76. The composite material of claim 58, wherein the carbon-based core has a bulk density in a range of about 0.25 g/cc to about 1.0 g/cc, a pore volume of at least 0.3 cc/g, and a porosity from 10% to 90% of a volume of the core.

77. The composite material of claim 58, wherein the carbon-based core comprises a skeletal framework, the skeletal framework comprising an array of interconnected pores.
